(19) United States
(12) Patent Application Publication
(10) Pub. No.: US 2012/0077696 A1
(43) Pub. Date: Mar. 29, 2012

(54) SOLUBLE HLA COMPLEXES FOR USE IN DISEASE DIAGNOSIS

(75) Inventors: Arie Admon, Tivon (IL); Michal Bassani-Sternberg, Haifa (IL)

(73) Assignee: Technion Research and Development Foundation Ltd., Haifa (IL)

(21) Appl. No.: 13/256,712

(22) PCT Filed: Mar. 14, 2010
(86) PCT No.: PCT/IL2010/000212

§ 371 Date: Nov. 28, 2011

Related U.S. Application Data
(60) Provisional application No. 61/160,316, filed on Mar. 15, 2009.

(51) Int. Cl. C40B 30/04; C40B 40/10

(52) U.S. Cl. 506/9; 506/18

(57) ABSTRACT

The invention relates to diagnostic kits, methods of diagnosing, prognosing and staging diseases, and immunogenic compositions. The invention is based on the detection of peptides associated with circulating soluble HLA complexes in particular disease states, including malignant diseases.

### FIELD OF THE INVENTION

The invention relates to diagnostic kits, methods of diagnosing, prognosing and staging diseases, and immunogenic compositions. The invention is based on the detection of peptides associated with circulating soluble HLA complexes in disease states, in particular malignant diseases.

### BACKGROUND OF THE INVENTION

Identification of serum biomarkers for diseases, such as cancer and autoimmunity, is one of the major goals of modern proteomics. Research in this direction has led to only a very limited arsenal of markers due to a number of obstacles, including: 1) cellular proteins are readily cleared from circulation or degraded; 2) disease related proteins are often present in circulation in quantities insufficient for detection by conventional methods; 3) many abundant serum proteins are also products of non-diseased cells. Thus, focus was redirected to the peptide degradation products of cancer proteins as serum biomarkers [1]. However, since small peptides are also unstable in the serum, attention was further redirected to peptides adsorbed to serum albumin, the latter of which has been termed a “molecular sponge”, since it binds different peptides and delays their filtration out of the serum or degradation by endogenous enzymes [2, 3]. The array of peptides present in serum has been termed the serum peptidome. The technique of “immuno-mass spectrometry” (“immuno-MS”) has been disclosed for separation of subsets of such peptides adsorbed to serum albumin followed by analysis by mass spectrometry [1].

Molecules of the major histocompatibility complex (MHC; also termed the human leukocyte antigen (HLA) in humans) are membrane bound proteins present at the cell surface of most nucleated cells, which serve to transport and display (or “present”) peptide antigens to cells of the immune system. HLA class I (HLA-I) molecules are composed of a polymorphic alpha chain non-covalently associated with a conserved 132-microglobulin subunit. Their peptide binding specificity is haplotype specific, and is defined by the binding “pocket” or “cleft”, formed by two of the three extracellular domains of the alpha chain i.e. domains α1 and α2 which fold into a groove-like structure. Peptides of about eight to ten residues can be accommodated by the binding pocket, with longer peptides bulging out in the middle. The term “HLA peptidome” has been used to describe the pool of peptides which specifically interacts with a particular HLA-I haplotype, and can encompass thousands of different sequences.

Classical HLA-I molecules are highly polymorphic and include HLA-A, HLA-B and HLA-C, while non-classical HLA-I molecules are non-polymorphic and include HLA-E, HLA-G and HLA-H. Soluble forms of HLA-I (sHLA-I), both classical and non-classical molecules, have been identified in the serum of both healthy and diseased individuals. However, significantly elevated sHLA-I levels have been identified in patients suffering from certain cancers and autoimmune diseases, and the level of sHLA-I has been proposed to serve as a prognostic indicator for such diseases [6-17]. For example, high levels of sHLA-I in multiple myeloma patients has been significantly associated with poor overall survival [12]. Nocito et al. disclose elevated levels of sHLA-I in Non-Hodgkin's Lymphoma (NHL) and Hodgkin's Disease (HD), while patients in remission exhibit normal levels (Nocito et al., Hum Immunol 1997, 58:106-11). Rebman et al. disclose significantly elevated levels of sHLA-G in patients with malignant melanoma, breast and ovarian cancer (Rebman et al., Semin Cancer Biol 2003, 13:371-7).

U.S. Patent Application Publication No. 2005/0053918 of some of the present inventors discloses a method of identifying peptides originating from a particular cell type and being capable of binding to MHC molecules of a particular haplotype, the method comprising obtaining a cell type expressing a soluble and secreted form of the MHC molecules of the particular haplotype; collecting the soluble and secreted form of the MHC molecules of the particular haplotype; and analyzing peptides bound to the soluble and secreted form of the MHC molecules of the particular haplotype. According to the disclosure, cells expressing soluble MHC may be produced by transfecting cell lines with plasmids encoding soluble MHC molecules, and the soluble MHC secreted to the culture medium is purified by immunoaffinity chromatography; thereafter MHC bound peptides are recovered and sequenced by electrospray tandem mass spectrometry.

PCT publication No. WO 2007/022248 discloses methods of detecting prostate, bladder and breast cancer comprising detecting increase in specified peptide fragments. According to the disclosure, the identification of cancer in a subject uses serum peptide profiles, which can by determined using mass spectrometry.

U.S. Patent Application Publication No. 2008/0172184 discloses a method of diagnosing or monitoring a condition of interest in a subject, comprising generating a signature thermogram containing a protein composition pattern for a sample from the subject; and comparing the signature thermogram to a standard thermogram associated with an absence of the condition of interest. According to the disclosure, the method is applicable to conditions including various cancers, autoimmune disease, bacterial and viral diseases.

U.S. Patent Application Publication No. 2007/0292869 discloses methods for diagnosing, monitoring and assessing risk of renal cell cancer, comprising determining the level of a marker peptide in a biological sample such as plasma; and comparing the level of the marker in the sample to a reference value, wherein the marker is selected from specified polypeptides and polynucleotides encoding same. According to the disclosure, the marker peptides may be identified by mass spectrometry (MS), following affinity absorption of the sample so as to deplete abundant plasma proteins, trypsin digestion and size fractionation of peptides.

U.S. Patent Application Publication No. 2007/0249000 discloses a method for diagnosing a person suspected of having B-cell non-Hodgkin's lymphoma or at risk of developing same, the method comprising providing a sample of a body fluid or a tissue, said sample containing a mixture of uncharacterized proteins, peptides or protein fragments naturally occurring in the sample; pre-processing the patient sample to make it amenable to analysis by mass spectrometry; generating a mass spectrum of the sample; and applying mathematical algorithm(s) to differentiate whether the mass spectrum of the sample has features characteristic of other samples from a reference database.

U.S. Patent Application Publication No. 2008/0286814 discloses a method for detecting an ovarian cancer in a subject, the method comprising detecting the presence and/or amount of one or more biomarkers in a biological sample from a subject, wherein at least one of the biomarkers is one of a number of specified peptides, and wherein the presence and/or amount of the biomarker peptide in the biological sample indicates that the subject has an ovarian cancer.

U.S. Patent Application Publication No. 2009/0035797 discloses a method for detecting disease associated proteolysis, comprising: providing a biological sample from a mammal; isolating all low molecular weight peptides having a molecular weight of not more than approximately 12,000 Daltons; directly detecting and determining the amino acid sequences of said isolated peptides by ionization mass spectrometry; and relating the determined sequence information to a reference standard.

PCT publication No. WO 2006/063844 discloses a purified monomeric soluble HLA-E molecule and a method for producing same from cell culture medium. Further disclosed is an in vitro method for diagnosing cancers or inflammatory diseases in a patient, comprising detecting the presence of soluble HLA-E in a biological sample from the patient, in particular blood, serum or plasma.

U.S. Patent Application Publication No. 2006/0276629 discloses recombinantly produced soluble HLA molecules purified substantially away from other proteins such that the soluble HLA molecule maintains the functional and antigenic integrity of the native HLA molecule. According to the disclosure, the soluble HLA molecule may be purified by immunoaffinity chromatography, may be a class I HLA molecule, and may have an endogenous peptide loaded therein.

U.S. Patent Application Publication No. 20020156773 discloses a method of accessing soluble HLA ligand data stored in a database. According to the disclosure, the ligands are obtained from recombinantly produced soluble HLA molecules, and the ligand database contains data sets of amino acid sequences of: individual endogenously loaded ligands for any specific HLA allele; motifs of endogenously loaded ligands; endogenous ligands loaded uniquely in infected cells (viral or bacterial); and ligands endogenously loaded uniquely in tumor or cancerous cells.

Pieper et al., discloses immunoaffinity-based protein subtraction chromatography as a technique suitable for removal of abundant plasma and serum proteins prior to further analysis of serum proteins by two-dimensional electrophoresis or mass spectroscopy. According to the disclosure, polyclonal antibodies directed to albumin, immunoglobulin G, immunoglobulin A, transferrin, haptoglobin, alpha-1-antitrypsin, hemopexin, transthyretin, alpha-2-HS glycoprotein, alpha-1-acid glycoprotein, alpha-2-macroglobulin and fibrinogen were used to remove those proteins from human plasma samples (Pieper et al., 2003 Proteomics 3:422-432).

Villanueva et al., 2004 discloses serum peptide profiling by magnetic particle-assisted, automated sample processing and MALDI-TOF mass spectrometry (Villanueva et al., 2004 Anal Chem. 76(6):1560-70). According to the disclosure, peptides are captured and concentrated using reversed-phase batch processing in a magnetic particle-based format. Villanueva et al., 2006 discloses identification of tumor-specific serum peptidome patterns using a matrix assisted laser desorption/ionization time-of-flight (MALDI-TOF) MS-based approach (Villanueva et al., 2006 J. Clin Invest 116:271-284).

Hofmann et al disclose methods for identification of MHC Class I-associated tumor antigens by nano-LC MALDI mass spectrometry. According to the disclosure, HLA complexes were isolated from renal cell carcinoma cell lysate using HLA allele specific antibodies (Hofmann et al., Mol Cell Proteomics 2005 December; 4(12):1888-97

Prior art methods for diagnosing diseases based on MS analysis of peptides present in serum, such as those described above, suffer from a number of drawbacks. For example, techniques aimed at analysis of peptides eluted from serum albumin are disadvantageous since even small amounts of contaminating serum albumin disrupt mass spectrometry analysis. Other methods do not provide a means of concentrating peptides prior to MS analysis, thus peptides present at very low concentrations, for example at early sub-clinical stages of disease, remain undetectable. Yet other methods comprise pre-processing steps which cannot be uniformly applied for detecting peptides associated with different types of diseases, for example cancers and autoimmune disorders.

There remains an unmet need for methods which can form the basis of a simple, routine and specific early detection tool for various life threatening diseases, and/or as a means of grading or prognosing diseases already diagnosed.

### SUMMARY OF THE INVENTION

The present invention provides in vitro methods for diagnosing diseases, based on identification of endogenous disease-associated peptide markers which in vivo are non-covalently bound to soluble histocompatibility antigens (sHLA) present in body fluids. The sHLA molecules carrying such peptides are isolated from samples from subjects, and the array of peptides therein is analyzed so as to characterize an sHLA-peptidome.

As used herein the term “sHLA-peptidome” refers to the qualitative and/or quantitative pattern of peptides associated with sHLA-I molecules present in the circulation (e.g. blood, plasma, serum and fractions thereof) or another body fluid of a subject. When the sample is serum, the array of peptides is termed herein the serum sHLA or ssHLA-peptidome.

The present invention is based, in part, on the unexpected discovery that thousands of sHLA-I associated peptides can be isolated, identified and quantified using small volumes (i.e. 10 ml or less) of blood samples, forming the basis for sHLA-peptidome diagnostic procedures for a variety of disease states. The invention is further based on the demonstration that subsets of certain sHLA-I associated peptides form unique patterns that represent such disease states. Thus, these sHLA-peptidomes may serve as diagnostic and prognostic disease markers.

The present invention is also based, in part, on the observation that cancer cells release to the serum large amounts of sHLA-I molecules, and the bound peptides attached thereto represent the repertoire of proteins synthesized and degraded within the cancer cells, including defective ribosome products. Without wishing to be bound by any theory or mechanism of action, it is believed that many of the peptides in the sHLA-I peptidome are derived from proteins which are biomarkers for cancer. Thus such peptides may serve as candidates for development of suitable antigens for cancer vaccine immunotherapy.

A significant advantage of the present invention over previously known diagnostic methods resides in the use of a purified pool of sHLA-I molecules, preferably obtained by immunoaffinity chromatography, as the source of the peptides for identification and quantification. Thus with relative ease, sufficient amounts of serum peptides may be obtained in purified form from small clinical samples, so as to enable detection of potentially informative peptides which in vivo are present only at very low concentrations. The degree of enrichment of the peptides provided by the current invention is estimated to be at least five orders of magnitude greater than that provided by methods which lack such an immunoaffinity or similar enrichment step. Furthermore, the method of the invention is suitable for adaptation into an array-based blood test carried out in a clinical laboratory setting, either for early diagnostic screening for a wide variety of cancers, or for monitoring and prognosis of patients previously diagnosed with cancer.

The principles of the present invention are demonstrated herein using serum and bone marrow samples from human patients having various hematologic malignancies, in particular, multiple myeloma (MM), acute myeloid leukemia (AML), and acute lymphoblastic leukemia (ALL) and serum samples from healthy human controls. The experimental results disclosed herein indicate that the serum sHLA-I peptidome of diseased subjects includes peptides that are not present in the serum sHLA-I peptidome of healthy subjects, and a significant proportion of the peptides are derived from cancer associated antigens. Further and significantly, the present inventors have shown that the sHLA-I peptidome of cancer cells is highly reflective of the corresponding membrane bound HLA-I (mHLA-I) peptidome from the same cells, supporting the validity of using the sHLA-I peptidome for diagnosis of a variety of cancers, including solid tumors. Furthermore, repeated analyses of the sHLA peptidomes collected from the same blood donors on separate days and processed separately, resulted in very similar sHLA peptidomes, thus indicating the very high reproducibility of the method.

In a first aspect, the invention provides a method for diagnosing a disease in a subject, the method comprising the steps of:
(i) selecting a suitable biological fluid sample;
(ii) processing the biological fluid sample so as to obtain an enriched pool of endogenous sHLA-I molecules with peptide ligands bound thereto from said sample; and
(iii) detecting at least one disease-associated peptide in the pool of sHLA-I molecules with peptide ligands bound thereto obtained in step (ii); wherein the amount of the at least one disease-associated peptide relative to the amount of said disease-associated peptide determined in a reference sample from at least one non-diseased subject, is indicative of a disease in the subject.

In another aspect, the invention provides a method of determining the risk of developing a disease in a subject, the method comprising the steps of:
(i) selecting a suitable biological fluid sample;
(ii) processing the biological fluid sample so as to obtain an enriched pool of endogenous sHLA-I molecules with peptide ligands bound thereto from said sample; and
(iii) detecting the presence of at least one disease-associated peptide from the pool of sHLA-I molecules with peptide ligands bound thereto obtained in step (ii); wherein the amount of the at least one disease-associated peptide relative to the amount of said disease-associated peptide determined in a reference sample from at least one non-diseased subject, is indicative of the risk in the subject for developing a disease.

In another aspect, the invention provides a method of staging or prognosing a malignant disease in a subject, the method comprising the steps of:
(i) selecting a suitable biological fluid sample;
(ii) processing the biological fluid sample so as to obtain an enriched pool of endogenous sHLA-I molecules with peptide ligands bound thereto from said sample; and
(iii) detecting the presence of at least one malignant disease-associated peptide from the pool of sHLA-I molecules with peptide ligands bound thereto obtained in step (ii); wherein the amount of the at least one disease-associated peptide relative to the amount of said disease-associated peptide determined in a reference sample from at least one different diseased subject having a known stage or outcome of the same malignant disease, is indicative of the stage or prognosis of the malignant disease in the subject.

In another aspect, the invention provides a method for determining the suitability of a subject for administration of an immunogenic composition directed against a malignant disease, the method comprising the steps of:
(i) selecting a suitable biological fluid sample;
(ii) processing the biological fluid sample so as to obtain an enriched pool of endogenous sHLA-I molecules with peptide ligands bound thereto from said sample; and
(iii) detecting at least one disease-associated peptide from the pool of sHLA-I molecules with peptide ligands bound thereto obtained in step (ii); wherein the amount of the at least one disease-associated peptide relative to the amount of said disease-associated peptide determined in a reference sample from at least one different diseased subject, is indicative of the suitability of the subject for administration of an immunogenic composition.

In particular embodiments of the methods disclosed herein, the biological fluid sample is selected from blood, plasma, serum, a bone marrow aspirate, a plasmapheresis sample, a leukopheresis sample, saliva, urine, cerebral spinal fluid, semen, tears or mucus. In particular embodiments, the biological fluid sample is plasma or serum. In particular embodiments, the method further comprises removing cells from the biological fluid sample prior to step (ii).

In particular embodiments, the disease is a malignant disease. In particular embodiments, the subject is a human or a non-human mammalian species.

In particular embodiments, step (ii) comprises contacting the biological fluid sample with a solid substrate, wherein the solid substrate comprises an immobilized antibody having specificity for sHLA-I, so as to bind sHLA-I molecules with peptide ligands bound thereto present in the sample; and thereafter dissociating bound sHLA-I molecules from the solid substrate, so as to obtain an enriched pool of sHLA-I molecules with peptide ligands bound thereto. In particular embodiments, the solid substrate comprising an immobilized antibody comprises at least one of immunoaffinity beads, a microaffinity column, a microwell plate, or a combination thereof. In particular embodiments, the antibody has specificity for at least one sHLA-I protein selected from the group consisting of sHLA-A, sHLA-B, sHLA-C, sHLA-E, sHLA-G, sHLA-H and combinations thereof. In particular embodiments, the antibody has specificity for all of sHLA-A, sHLA-B and sHLA-C. In particular embodiments, the antibody has specificity for an sHLA-I protein supertype selected from the group consisting of A01; A01 A03; A01 A24; A02 A03; A24; B07; B08; B27; B44; B58; B62, Cw1; Cw2; Cw3; Cw4; Cw5; Cw6; Cw7; Cw8; Cw9(w3); Cw10(w3) and combinations thereof.

In particular embodiments, the enrichment factor of the sHLA-I molecules with peptide ligands bound thereto in the pool obtained in step (ii) is at least 1000 relative to the biological fluid sample. In particular embodiments, the enrichment factor of the sHLA-I molecules with peptide ligands bound thereto in the pool obtained in step (ii) is at least 10,000 relative to the biological fluid sample. In particular embodiments, the enrichment factor of the sHLA-I molecules with peptide ligands bound thereto in the pool obtained in step (ii) is at least 100,000 relative to the biological fluid sample.

In particular embodiments, the operation of dissociating bound sHLA-I molecules from the solid substrate performed in step (ii) comprises contacting the solid substrate with an acidic, basic or chaotropic solution. In particular embodiments, the operation of dissociating bound sHLA-I molecules from the solid substrate performed in step (ii) comprises heating

In particular embodiments, any of the methods disclosed herein comprise an additional step (iv) carried out prior to step (iii), wherein step (iv) comprises dissociating the peptide ligands bound to the sHLA-I molecules obtained in (ii), so as to obtain a pool of peptides. In particular embodiments, step (iv) comprises contacting the pool of sHLA-I molecules with an acidic, basic or chaotropic solution. In particular embodiments, step (iv) comprises heating the pool of sHLA-I molecules. In particular embodiments, the operation of dissociating bound sHLA-I molecules from the solid substrate carried out in step (ii) and the operation of dissociating the peptide ligands bound to the sHLA-I molecules carried out in step (iv) are performed in a single operation. In particular embodiments, said single operation comprises heating. In particular embodiments, step (iv) further comprises isolating the dissociated peptides from the sHLA-I molecules. In particular embodiments, the isolating comprises at least one operation selected from the group consisting of heating, centrifugation and filtration.

In particular embodiments, the enrichment factor of the peptides in the pool obtained in step (iv) is at least 1000 relative to the biological fluid sample. In particular embodiments, the enrichment factor of the peptides in the pool obtained in step (iv) is at least 10,000 relative to the biological fluid sample. In particular embodiments, the enrichment factor of the peptides in the pool obtained in step (iv) is at least 10,000 relative to the biological fluid sample.

In particular embodiments, the detecting in step (iii) comprises at least one of mass spectrometry, an immunoassay or an array-based binding assay system. In particular embodiments, the immunoassay or array-based detection system comprise a solid substrate. The solid substrate used in step (iii) may be the same or different from a solid substrate used in step (ii). In particular embodiments, the immunoassay comprises ELISA. In particular embodiments, the solid substrate used in step (iii) comprises at least one binding reagent having specificity for at least one disease-associated peptide amino acid sequence.

In particular embodiments, the solid substrate used in step (iii) comprises a plurality of binding reagents wherein each binding reagent has specificity for a different peptide amino acid sequence. In particular embodiments, the at least one binding reagent is selected from the group consisting of an antibody, an antibody fragment and a TCR-like molecule. In particular embodiments, the detecting in step (iii) comprises use of a TCR-like molecule, and step (iv) is not performed. That is, a peptide ligand in association with its cogent sHLA-I molecule may be detected using a TCR-like molecule, which mimics the ability of a native TCR to recognize peptide antigen in the context of the HLA-I binding cleft. In particular embodiments, the immunoassay or the array-based binding assay system comprise detection of a signal selected from a fluorescent signal, a chemiluminescent signal and a plasmon resonance signal.

In particular embodiments, the disease is a malignant disease and the at least one disease-associated peptide has an amino acid sequence selected from the group consisting of SEQ ID NOS: 1-276 and combinations thereof. In particular embodiments, the malignant disease is a hematologic cancer and the at least one disease-associated peptide has an amino acid sequence selected from the group consisting of SEQ ID NOS: 1-276 and combinations thereof. In particular embodiments, the hematologic cancer is selected from the group consisting of multiple myeloma (MM), acute lymphoblastic leukemia (ALL), acute myeloid leukemia (AML), chronic lymphocytic leukemia (CLL), chronic myelogenous leukemia (CML), Hodgkin's disease, non-Hodgkin's lymphoma and hairy cell leukemia. In particular embodiments, the hematologic cancer is acute myeloid leukemia and the disease-associated peptide has an amino acid sequence selected from the group consisting of SEQ ID NOS: 1-78 and combinations thereof. In particular embodiments, the hematologic cancer is multiple myeloma and the disease-associated peptide has an amino acid sequence selected from the group consisting of SEQ ID NOS: 79-166 and combinations thereof. In particular embodiments, the hematologic cancer is acute lymphoblastic leukemia and the disease-associated peptide has an amino acid sequence selected from the group consisting of SEQ ID NOS: 167-216 and combinations thereof. In particular embodiments, the hematologic cancer is selected from the group consisting of multiple myeloma, acute myeloid leukemia and acute lymphoblastic leukemia and the disease-associated peptide has an amino acid sequence selected from the group consisting of SEQ ID NOS: 217-237 and combinations thereof. In particular embodiments, the malignant disease is a hematologic cancer and the disease-associated peptide has an amino acid sequence selected from the group consisting of SEQ ID NOS: 238-276 and combinations thereof.

In particular embodiments of the methods of diagnosing a disease, the subject does not exhibit clinical signs of disease. In particular embodiments, the methods further comprise determining the HLA haplotype of the subject. In particular embodiments, the methods further comprise determining at least one HLA-I allele expressed by the subject, wherein the HLA-I allele is of a locus selected from the group consisting of HLA-A, HLA-B, HLA-C, HLA-E, HLA-G, HLA-H and a combination thereof.

In another aspect, the invention provides a diagnostic kit, the kit comprising a first solid substrate comprising an immobilized binding reagent having specificity for sHLA-I, and a second solid substrate comprising at least one immobilized binding reagent having specificity for at least one disease-associated peptide amino acid sequence. In a particular embodiment, the second solid substrate comprises a plurality of different binding reagents, wherein the different binding reagents are directed to different peptide amino acid sequences. In particular embodiments, the binding reagent having specificity for sHLA-I is selected from the group consisting of an antibody and an antibody fragment. In particular embodiments, the at least one binding reagent having specificity for at least one disease-associated peptide is selected from the group consisting of an antibody, an antibody fragment and a TCR-like molecule. In particular embodiments, the TCR-like molecule is a TCR-like antibody. In a particular embodiment, the second solid substrate comprises an immunoassay or an array-based binding assay system. In particular embodiments, the immunoassay comprises ELISA. In particular embodiments, the immunoassay or the array-based binding assay system comprise detection of a signal such as a fluorescent signal, a chemiluminescent signal or a plasmon resonance signal.

The invention is relevant to a variety of malignant diseases, as well as autoimmune diseases and infectious diseases. Malignant diseases include for example, hematologic cancers, bladder cancer, bone cancer, breast cancer, cervical cancer, colon cancer, endometrial cancer, gastric cancer, head and neck cancer, hepatic cancer, kidney cancer, lung cancer, melanoma, ovarian cancer, pancreatic cancer, prostate cancer, renal cancer, sarcoma, skin cancer, stomach cancer, testicular cancer and thyroid cancer. Autoimmune diseases include for example, multiple sclerosis, arthritis, psoriatic spondylitis, spondyloarthropathy, celiac disease, systemic lupus erythematosus (SLE), myasthenia gravis, inclusion body myositis, Sjögren's syndrome, narcolepsy, diabetes, Crohn's Disease and Behçet's syndrome. Infectious diseases include for example bacterial, parasitic and viral diseases.

In another aspect, the invention provides an immunogenic composition, the composition comprising a therapeutic amount of at least one isolated peptide selected from the group consisting of the SEQ ID NOS: 1-276, or a salt or a derivative thereof; and at least one pharmaceutically acceptable adjuvant, carrier or diluent.

Other objects, features and advantages of the present invention will become clear from the following description and drawings.

### BRIEF DESCRIPTION OF THE FIGURES

FIG. 1 shows a schematic flow-chart of one embodiment of the invention.

FIG. 2 shows Western blot analysis of immunoaffinity purified HLA-I molecules.

FIG. 2A shows analysis of serum sHLA-I from peripheral blood and bone marrow from patients with multiple myeloma (MM#1 and MM#2) and acute myeloid leukemia (AML-1) and from a healthy control subject.

FIG. 2B shows analysis of sHLA-I from conditioned medium of multiple myeloma cell lines U266, L363, and RPMI8226, and the mHLA-I from the same cell lines and from cells of patient AML-1.

FIG. 3 shows scatter plots based on LC-MS signal intensities, indicating the degree of similarity of the sHLA peptidome determined for different plasma samples obtained from healthy subjects (Healthy-5 and Healthy-6).

Samples were either collected on separate days (day 1 and day 2; FIG. 3A and FIG. 3B respectively), or a single sample was collected and divided into two (sample #1 and sample #2) prior to processing (FIG. 3C). The peptide extractions and analyses were performed independently. The empty square symbols indicate high score peptides with Pep-Miner score ≧85, and the filled diamond symbols indicate low score peptides with Pep-Miner score <85.

FIG. 3A shows a scatter plot of sHLA peptides obtained from Healthy-5 on day 1 and day 2.

FIG. 3B shows a scatter plot of sHLA peptides obtained from Healthy-6 on day 1 and day 2.

FIG. 3C shows a scatter plot of sHLA peptides obtained from a single sample of Healthy-5 that was divided into two.

FIG. 4 shows scatter plots based on LC-MS signal intensities, indicating the degree of similarity between sHLA peptidomes from different subjects. The empty square symbols indicate high score peptides with Pep-Miner score ≧85, and the filled diamond symbols indicate low score peptides with Pep-Miner score <85.

FIG. 4A shows a scatter plot of sHLA peptides in plasma samples from a diseased subject with acute myeloid leukemia (AML-1) and from a healthy subject (Healthy-1).

FIG. 4B shows a scatter plot of sHLA peptides from two different subjects with multiple myeloma (MM-1 and MM-2).

FIG. 4C shows a scatter plot of sHLA peptides from two healthy subjects (Healthy-2 and Healthy-3).

FIG. 5 shows scatter plots based on LC-MS signal intensities, indicating the degree of similarity between sHLA peptides and mHLA peptides isolated from subjects with hematologic cancers. The empty square symbols indicate high score peptides with Pep-Miner score ≧85, and the diamond symbols indicate low score peptides with Pep-Miner score <85.

FIG. 5A shows a scatter plot of sHLA peptides isolated from plasma and mHLA peptides isolated from cancer cells of a subject with acute myeloid leukemia (AML-1).

FIG. 5B shows a scatter plot of sHLA peptides isolated from plasma and mHLA peptides isolated from cancer cells of a different subject with acute myeloid leukemia (AML-3).

FIG. 5C shows a scatter plot of sHLA peptides isolated from plasma and mHLA peptides isolated from cancer cells of a subject with acute lymphoblastic leukemia (ALL-1).

FIG. 5D shows a scatter plot of sHLA peptides and mHLA peptides isolated from bone marrow of the same subject analyzed in FIG. 5C.

FIG. 6 shows scatter plots based on LC-MS signal intensities, indicating the degree of similarity between sHLA peptides isolated from plasma and from bone marrow of subjects with hematologic cancers. The empty square symbols indicate high score peptides with Pep-Miner score ≧85, and the diamond symbols indicate low score peptides with Pep-Miner score <85.

FIG. 6A shows a scatter plot of sHLA peptides isolated from plasma and from bone marrow of a subject with multiple myeloma (MM-1).

FIG. 6B shows a scatter plot of sHLA peptides isolated from plasma and from bone marrow of a different subject with multiple myeloma (MM-2).

FIG. 6C shows a scatter plot of sHLA peptides isolated from plasma and from bone marrow of a subject with acute lymphoblastic leukemia (ALL-1).

FIG. 7 shows scatter plots based on LC-MS signal intensities, indicating the degree of similarity between sHLA peptides isolated from growth medium and sHLA peptides isolated from cells of the same multiple myeloma cell line. The empty square symbols indicate high score peptides with Pep-Miner score ≧85, and the diamond symbols indicate low score peptides with Pep-Miner score <85.

FIG. 7A shows a scatter plot of sHLA peptides and mHLA peptides isolated from cell line U266.

FIG. 7B shows a scatter plot of sHLA peptides and mHLA peptides isolated from cell line L363.

FIG. 7C shows a scatter plot of sHLA peptides and mHLA peptides isolated from cell line RPMI8226.

FIG. 8 shows gene ontology analysis of biological processes associated with the proteins of origin of isolated sHLA peptides.

FIG. 8A shows gene ontology analysis of peptides isolated from plasma of subjects MM-1 (black bars), MM-2 (gray bars), AML-1 (stippled bars) and Healthy-1 (diagonally striped bars).

FIG. 8B shows comparative gene ontology analysis of sHLA peptides (black bars) and mHLA peptides (gray bars) isolated from subject AML-1.

### DETAILED DESCRIPTION OF THE INVENTION

The present invention utilizes (i) the elevated levels of serum sHLA-I (ssHLA-I) that occur in serious diseases, and (ii) the altered sHLA-I peptidome characteristic of certain diseases, for development of diagnostic methods. The methods of the invention are in particular directed to cancer, but may also be applied to various autoimmune and infectious diseases.

The present inventors have shown that using small amounts of serum samples, the peptides associated with sHLA-I may be purified in sufficient amounts for molecular diagnosis and prognosis. The diagnostic criterion is based on the identification of at least one disease-associated peptide in the sHLA-I peptidome of a subject. The sensitivity of the method enables early diagnosis, or determination of the risk of disease development, even prior to clinical manifestation of disease. Thus, the invention provides a basis for programs of health monitoring and early screening, which initially establish “normal” or “baseline” sHLA peptidome footprints of healthy individuals. Changes detected in such footprints during periodic medical check-ups can be indicative of imminent disease pathologies, and can also be used for development of personalized treatment regimens, based on the peptides detected.

Further, assessment of the levels of particular disease-associated peptides in the sHLA-I peptidome enables staging and prognosis of diseases that are already manifest and diagnosed.

The approach described herein is particularly useful for diagnostics based on the HLA-I peptidome reflective of cancer cells. The cancer HLA-I peptidome is largely derived from short-lived proteins and defective ribosome products (DRiPs). Since cancer cells tend to release large amounts of sHLA-I molecules, the bound peptides attached to these molecules are likely protected from filtration and degradation and are thus a good representation of the proteins synthesized and degraded within the cancer cells. The normal cells of the body do not release as large amounts of sHLA and thus the sHLA is most likely largely derived from the diseased cells. Cancer cells typically synthesize abnormal repertoires of proteins due to the prevalent loss of cellular control.

While sHLA-I peptide patterns will necessarily differ among individuals due to allelic variation, and the corresponding heterogeneity in peptide ligand binding specificity in expressed HLA-I proteins, the disclosed method enables diagnosis of cancers on the basis of detection of a range or repertoire of peptides derived from the same “cancer-specific” proteins. Thus, the same type of cancer may be diagnosed among individuals of differing HLA-I haplotype due to the presence of HLA-peptides derived from the same cancer biomarker proteins. In addition, in many cancer states, an abundance of sHLA-associated peptides are derived from proteins specifically expressed in the tissue affected by the cancer. Thus, the combination of sHLA-peptides reflecting “cancer-specific” proteins and those reflecting tissue specific proteins can be used for diagnosis according to the invention.

Accordingly, the present invention is advantageous over prior art methods which rely upon detection of peptides which are largely protease degradation products, rather than the natively processed HLA-I peptides reflective of cancer and tissue biomarkers utilized by the present invention. Furthermore, prior art methods which lack affinity enrichment are typically limited in the amounts of fluid samples which can be analyzed, due to rapid saturation of the mass spectrometry instrumentation by high concentrations of “non-interest” peptides. Thus, in contrast to the present invention, peptides of interest but of very low abundance will remain undetected.

Furthermore, the present invention enables detection of peptides which may be used as tumor antigen candidates in the development of anti-cancer vaccines. The peptides can be used for design of personalized immunotherapeutics, for rapid construction of mini-genes, selection of cytotoxic T cells, suppression of T-regulatory cells and production of recombinant TCRs, and TCR-like antibodies. The methods disclosed herein may be further useful for development of additional diagnostic and prognostic methods which rely on protein arrays composed of recombinant TCRs or TCR-like binding molecules specific for sHLA-I peptide complexes carrying disease marker sHLA peptides.

### DEFINITIONS

The terms “sHLA-I binding peptides”, “sHLA-I associated peptides”, “sHLA-I peptide ligands” and “sHLA-I ligands” are used interchangeably herein to refer to peptides of varying length and amino acid sequence which are recognized by and specifically interact with and bind within the binding pocket (also termed “binding cleft”) of a native sHLA-I molecule. The term “cogent” refers to this specific relationship when used in the context of HLA-I molecules and the peptides that specifically associate with those molecules.

As used herein, a “peptide” is a plurality of contiguous amino acid residues comprising from at least about 3 amino acid residues to about 50 amino acid residues. A peptide may represent a fragment of a larger polypeptide product from which it is derived for example, by proteolytic cleavage or other processing mechanisms. A peptide can comprise modified amino acid residues, amino acid analogs or non-naturally occurring amino acid residues and can be interrupted by non-amino acid residues. Included within the definition are peptides that have been modified, whether naturally or by intervention, e.g., formation of a disulfide bond, glycosylation, lipidation, methylation, acetylation, phosphorylation, or by manipulation, such as conjugation with a labeling component.

As used herein, the terms “sHLA-I” and “sHLA” refer interchangeably to any non-cell bound form of HLA-I, including in particular circulating forms of HLA-I found in body fluids such as serum. The term includes for example, the full sized molecule including the transmembrane domain; molecules lacking the transmembrane domain but including the cytoplasmic domain, and molecules lacking both the transmembrane and the cytoplasmic domains. Further encompassed are splice variants and proteolytic products thereof. Further, sHLA-I molecules may be of any of the HLA class I classical and non-classical gene products, including HLA-A, HLA-B, HLA-C, HLA-D, HLA-E, HLA-F, HLA-H, HLA-J, HLA-K, HLA-L, HLA-P, HLA-T, HLA-U, HLA-V, HLA-W and HLA-X, and any of their polymorphic alleles.

It is to be understood that when the invention is applied to a non-human subject, the equivalent forms of soluble MHC-I are intended.

As used herein, the term “endogenous sHLA-I molecules” refers to native sHLA-I molecules found in a subject or cell culture system, and does not encompass soluble HLA-I molecules which have been rendered soluble by manipulation, for example, by recombinant engineering of the genes encoding the corresponding membrane-bound HLA-I form, or by extraction of membrane-bound HLA-I. As used herein, the term “pool of sHLA-I molecules” refers to a fraction of sHLA-I protein molecules which may or may not be in association with their respective peptide ligands.

As used herein, the term “pool of sHLA-I molecules with peptide ligands bound thereto” refers to a fraction of sHLA-I molecules in association with their respective peptide ligands.

As used herein, the term “an enriched pool of endogenous sHLA-I molecules” refers to a fraction of endogenous sHLA-I molecules which are at least partially purified relative to the source or starting material. That is, the concentration of the sHLA-I molecules in the pool relative to the total amount of proteins in the pool, is greater that the concentration of the sHLA-I molecules in the starting material relative to the total amount of proteins in the starting material. Similarly, the term “enrichment factor” refers to the relative degree of purification of proteins or peptides in a fraction, relative to the starting material.

In accordance with the invention, an enriched pool of endogenous sHLA-I molecules is preferably obtained in purified or semi-purified form by immunoaffinity chromatography using an antibody or other binding molecule having specificity for sHLA-I. It is to be explicitly understood that the pool can be heterogeneous in that it can contain diverse HLA-I supertypes and alleles.

As used herein, the term “isolated pool of peptides” refers to a homogeneous or heterogeneous fraction of peptides obtained in purified or semi-purified form upon dissociation and separation from their cogent HLA-I molecules.

As used herein, the term “disease-associated peptide” refers to a peptide found in a disease state in a manner that is qualitatively or quantitatively different from that found in anon-diseased state.

As used herein, “serum” refers to the fluid portion of blood obtained after removal of clotted fibrin and blood cells, distinguished from the plasma in circulating blood.

As used herein, “plasma” refers to the fluid, non-cellular portion of the blood, distinguished from the serum obtained after coagulation.

As used herein, the term “selecting” in reference to a biological fluid sample encompasses determining the suitability of a particular biological fluid sample for analysis.

As used herein, the term “obtaining” in reference to a biological fluid sample encompasses a wide variety of techniques for sample procurement from human subjects, including invasive or partially invasive procedures directly carried out by medical personnel, such as blood withdrawal or bone marrow aspiration, or non-invasive procedures in which the sample e.g., urine, saliva, is self-procured by the subject and transferred to medical personnel for further processing. The term further encompasses preliminary processing steps which facilitate sample handling and/or analysis, for example centrifugation and coagulation of blood so as to obtain serum.

As used herein, the term “detecting” in reference to an analyte such as a peptide, encompasses determining the presence and amount of that analyte in a particular sample, pool or mixture.

The term “affinity chromatography” refers to the separation of chemically different molecules in a mixture from one another by contact of the mixture with a solid phase adsorbent comprising a binding molecule, such as an antibody, having binding specificity for one or more components in the mixture. The ligand binds or retains the components for which it has specificity, while non-binding materials are not bound under the same conditions. Following washing to remove non-specifically bound molecules, specifically bound molecules are typically released i.e. “eluted” by application of a solution which effects change in conditions, typically pH, ionic strength, hydrophobicity, or degree of chaotropism or by exposure to elevated temperatures.

The terms “immunoaffinity chromatography” and “antibody affinity chromatography” are used interchangeably herein to refer to the type of affinity chromatography in which the binding molecule attached to the solid phase adsorbent is an antibody which is intended to specifically bind one or more antigens in the mixture to be separated.

As used herein, the term “solid support” refers to a solid material, which can be derivatized with, or otherwise attached to, a binding reagent, such as an antibody. Exemplary solid supports include probes, microliter plates and chromatographic resins.

The terms “array and “microarray” are used interchangeably herein to refer to a solid support that provides a plurality of locations at which molecules may be bound. The number of different kinds of molecules bound at one location is small relative to the total number of different kinds of molecules in the array. In many embodiments, only one kind of molecule is bound at each feature.

A “spatially addressable array” refers to an array in which the location of a molecule bound to the array can be recorded and tracked by its spatial address throughout any of the procedures carried out according to the invention. Spatial addressable arrays can be one dimensional, for example a linear array; two dimensional; or three dimensional. A particular position in an array is referred to as an “address” or “spot” or “locus”. Each address or spot has unique coordinates. The structure of a compound, for example the amino acid sequence of a peptide, immobilized at a particular address or spot is definable by its coordinates. Fluorescence tagged beads are also an addressable (liquid) array in which each bead is tagged with a different set of fluorescent colors and bound with an antibody, a TCR or a TCR-like molecule. The binding of specific sHLA-peptide complexes to such beads or array are detected with devices such as fluorescence scanners for arrays or FACS for beads.

As used herein, the terms “subject” and “patient” refer to humans and animals having an MHC system, such as the HLA system in humans, for which disease diagnosis, detection, prognosis, staging or therapy is desired. Also included are subjects involved in clinical research trials not showing any clinical sign of disease, or subjects involved in epidemiological studies, or subjects used as controls.

As used herein, the term “detecting” refers to methods which include identifying the presence or absence of peptide(s) in the sample, quantifying the amount of peptide(s) in the sample, and/or correlating the detected peptide amino acid sequence with the HLA haplotype specificity of the subject.

As used herein, the term “diagnosing” means identifying the presence or nature of a pathological disease condition, e.g., cancer, in a subject, and includes determination of a subject's susceptibility to a disease; determination as to whether a subject is presently affected by a disease; and determination of and monitoring the effect of a therapeutic treatment on the disease. While a particular diagnostic method may not provide a definitive diagnosis of a condition, it suffices if the method provides a positive indication that aids in diagnosis.

The terms “cancer”, “malignant disease”, “neoplastic disease”, “tumor”, and the like are used interchangeably herein to refer to conditions characterized by cells which exhibit relatively autonomous growth, so that they exhibit an aberrant growth phenotype characterized by a significant loss of control of cell proliferation.

As used herein, the term “stage” in reference to a disease, in particular a malignant disease, refers to a numerical measurement of the level of advancement of the disease. Accordingly, the terms “stage of cancer” and “stage of malignant disease” refer to a numerical measurement of the level of advancement of the cancer or malignant disease. Criteria used to determine the stage of a cancer include, but are not limited to, morphological characteristics of the cancer cells, tumor size, whether the cancer has spread to other parts of the body and to what extent the cancer has spread (e.g., within the same organ or region of the body or to another organ).

The term “prognosis” as used herein refers to the expected or predicted outcome of a disease, such as a cancer, in a patient following diagnosis. A prognosis may predict the relative chance of disease progression, arrest or cure. A prognosis may be established on the basis of prognostic indicators specific for a particular disease. Prognostic indicators in cancer may include for example, the grade and stage of cancer at initial diagnosis, the genetic make-up of the patient, the presence and level of cancer-associated antigens, and patient responsiveness to a particular therapy.

As used herein, “mass spectrometer” refers to a gas phase ion spectrometer that measures a parameter that can be translated into mass-to-charge ratios of gas phase ions and may provide information about the relative amounts of these ions. Mass spectrometers generally include an ion source and a mass analyzer. Examples of mass spectrometers are time-of-flight, magnetic sector, quadrupole filter, ion trap, ion cyclotron resonance, electrostatic sector analyzer and hybrids of these. “Mass spectrometry” refers to the use of a mass spectrometer to detect gas phase ions.

A “gas phase ion spectrometer” refers to an apparatus that detects gas phase ions. Gas phase ion spectrometers include an ion source that supplies gas phase ions. Gas phase ion spectrometers include, for example, mass spectrometers, ion mobility spectrometers, and total ion current measuring devices.

As used herein, “laser desorption mass spectrometer” refers to a mass spectrometer that uses laser energy as a means to desorb, volatilize, and ionize an analyte.

As used herein, “tandem mass spectrometer” refers to any mass spectrometer that is capable of performing at least two successive stages of m/z-based discrimination or measurement of ions, including ions in an ion mixture. The term includes mass spectrometers having two mass analyzers that are capable of performing two successive stages of m/z-based discrimination or measurement of ions tandem-in-space. The term further includes mass spectrometers having a single mass analyzer that is capable of performing two successive stages of m/z-based discrimination or measurement of ions tandem-in-time. The phrase thus explicitly includes Qq-TOF mass spectrometers, ion trap mass spectrometers, ion trap-TOF mass spectrometers, TOF-TOF mass spectrometers, Fourier transform ion cyclotron resonance mass spectrometers, orbitrap mass spectrometers, electrostatic sector-magnetic sector mass spectrometers, and combinations thereof.

As used herein, “mass analyzer” refers to a sub-assembly of a mass spectrometer that comprises means for measuring a parameter that can be translated into mass-to-charge ratios of gas phase ions. In a time-of-flight mass spectrometer the mass analyzer comprises an ion optic assembly, a flight tube and an ion detector.

As used herein, the term “MALDI” as used herein refers to Matrix-Assisted Laser Desorption/Ionization, a process wherein analyte is embedded in a solid or crystalline “matrix” of light-absorbing molecules (e.g., nicotinic, sinapinic, or 3-hydroxypicolinic acid), then desorbed by laser irradiation and ionized from the solid phase into the gaseous or vapor phase, and accelerated as intact molecular ions towards a detector. The “matrix” is typically a small organic acid mixed in solution with the analyte at a molar ratio of matrix/analyte e.g., 10,000:1. The matrix solution can be adjusted to neutral or acidic pH before use.

As used herein, the term “MALDI-TOF MS” refers to Matrix-Assisted Laser Desorption/Ionization Time-of-Flight mass spectrometry.

The terms “LC-MS peak area” and “LC-MS signal intensity” are used herein interchangeably to refer to the signal observed by the mass spectrometer. The term LC-MS peak area indicates the integral of the signal caused by a particular ion and detected by the mass spectrometer (MS) as it elutes from the liquid chromatography (LC) column. This is a frequently used way to follow the ‘signal intensity’ which correlates with the amount of a particular analyte. In some cases however, it may be sufficiently informative to more simply monitor the height of the peak as a measure of its ‘signal intensity’.

As used in the specification and the appended claims, the singular forms “a”, “an”, and “the” include plural referents unless the context clearly indicates otherwise. Thus, for example, reference to “a peptide” includes mixtures of peptides, and so forth.

### Methods of the Invention

The present invention encompasses methods of disease diagnosis using as a criterion the detection of particular sHLA-I-associated peptides. In particular embodiments, the peptides correspond to a particular disease “signature”. That is, the repertoire of sHLA-I-associated peptides found in a disease state is qualitatively or quantitatively different from that of a reference non-diseased sample. More particularly, the sHLA-I-associated peptidome found in a disease state includes at least one peptide or a peptide subset which does not form part of the sHLA-I-associated peptidome in a non-diseased state. Accordingly, detection of a unique peptide subset which is specific for a particular disease may be used for diagnosis.

Accordingly, the analyses described in Example 1 herein resulted in the identification of peptides which may be grouped according to the cancer or cancers of which they are indicative. More specifically, the sHLA-I-associated peptides having SEQ ID NOS: 1-78 were identified in patients with acute myeloid leukemia (AML), but not in any of the tested subjects having a different hematologic cancer, nor in any healthy subjects. The sHLA-I-associated peptides having SEQ ID NOS: 79-166 were identified in patients with multiple myeloma (MM), but not in any of the tested subjects having a different hematologic cancer, nor in any healthy subjects. The sHLA-I-associated peptides having SEQ ID NOS: 167-216 were identified in the patient with acute lymphoblastic leukemia (ALL), but not in any of the tested subjects having a different hematologic cancer, nor in any healthy subjects. The sHLA-I-associated peptides having SEQ ID NOS: 217-237 were identified in each disease state, i.e. at least one patient in each of the AML and MM groups, as well as the single ALL patient displayed these peptides. Accordingly, peptides having SEQ ID NOS: 217-237, and/or the proteins from which they are derived, correspond to potential candidates useful as diagnostic biomarkers for at least a subset of hematologic cancers.

Furthermore, certain peptides derived from tumor associated antigens were identified from sHLA-I of cancer patients, but the same peptides were not identified from sHLA-I of healthy control subjects. Examples of such peptides (SEQ ID NOS: 238-276) are disclosed in Table 2 herein.

It is to be expressly understood that the methods of the invention are directed to identification of peptides that are associated with endogenous i.e. native, sHLA-I molecules present in a human subject or a cell culture derived therefrom, and does not encompass use of sHLA molecules that have been rendered soluble by manipulation, for example by recombinant engineering of genes encoding HLA-I molecules, or chemically treated cell-associated HLA-I molecules.

The methods of the invention also encompass quantification of peptides for diagnosing, prognosing, staging or determining risk of disease. That is, if a particular peptide is present in a sample in an amount that is relatively elevated or decreased as compared to a reference value determined from non-diseased subjects, that elevated or decreased level can be used as an indicator of diagnosis or risk of the subject concerning the disease. Alternatively, if a subject has been already diagnosed with a particular disease, the presence of a particular peptide in an amount that is within the range determined from other patients having a known stage or outcome of the same disease, can be used as an indicator of stage of prognosis of the disease in the subject.

It is to be understood that a “reference sample” may be a single sample from a non-diseased subject or alternatively, from a subject having a known stage or outcome of a disease, but is preferably based on a set of subjects sufficiently large so as to optimize the specificity of the methods disclosed herein. As used herein, “specificity” refers to the percentage of subjects correctly identified as having a particular disease, or as having a particular stage of a particular disease, or as being at risk for developing a particular disease, or as having a particular outcome following diagnosis of a disease. Accordingly, a “reference amount” refers to an amount of a particular peptide determined by analysis of the reference sample. Detection of a particular peptide in a subject sample at a level that is greater or lesser than, or within the range of the reference amount determined for that peptide from the reference sample, can be used an indicator for diagnosis, prognosis or staging.

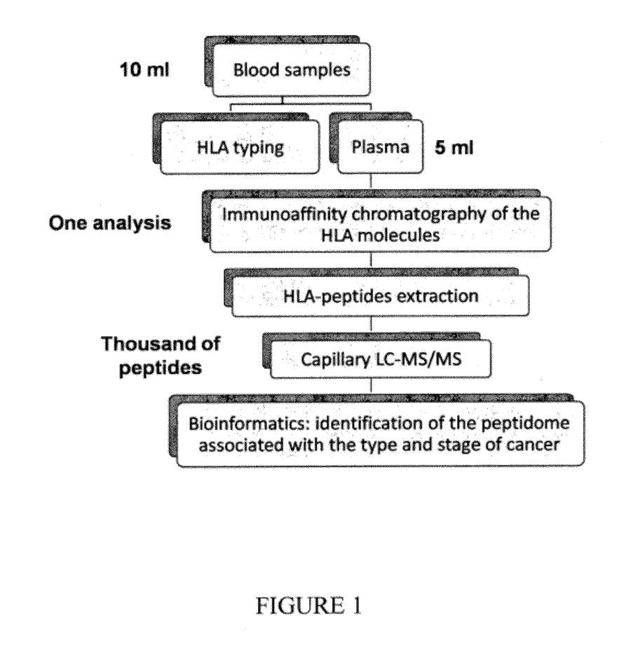

One embodiment of the methods of the invention is schematically represented in FIG. 1.

In particular embodiments, the methods of the invention comprise the steps of:
(i) selecting a suitable biological fluid sample;
(ii) processing the biological fluid sample so as to obtain an enriched pool of endogenous sHLA-I molecules with peptide ligands bound thereto from said sample; and
(iii) detecting at least one disease-associated peptide in the pool of sHLA-I molecules with peptide ligands bound thereto obtained in step (ii); wherein the amount of the at least one disease-associated peptide relative to the amount of said disease-associated peptide determined in a reference sample, is indicative of a disease, or a stage of a disease, or the prognosis of a disease in a subject.

The biological fluid sample may be blood, plasma, serum, a bone marrow aspirate, a plasmapheresis sample, a leukopheresis sample, saliva, urine, cerebral spinal fluid, semen, tears or mucus. In particular embodiments, the biological fluid sample is plasma or serum, which offer advantages for screening large numbers of samples, for example from different individuals. Blood samples are also highly useful in this respect. As disclosed in Example 1 herein, large numbers of cancer-related peptides have been identified from sHLA molecules isolated from patient serum samples. The methods of the invention may further include a step of removing cells from the biological fluid sample prior to step (ii). In a particular embodiment, the selected sample is obtained from the patient.

In particular embodiments, the reference sample is from at least one different subject having a known stage or outcome of the disease, and the method enables staging of or prognosing the disease in a subject previously diagnosed.

Step (ii) is conveniently carried out by contacting the biological fluid sample with a solid substrate which includes an immobilized antibody having specificity for sHLA-I. Accordingly, using immunoaffinity techniques well known in the art, sHLA-I molecules present in the sample may be purified and isolated on the basis of their specific binding to the antibody. One of skill in the art is capable of determining appropriate washing and elution conditions which will respectively eliminate non-specifically bound materials from the substrate, and thereafter dissociate (i.e. elute) specifically bound sHLA-I molecules from the solid substrate. Thus, an enriched pool of sHLA-I molecules and peptide ligands may be obtained

The solid substrate may comprise at least one of immunoaffinity beads, a microaffinity column, a microwell plate, or any combination thereof. The antibody may have specificity for all of sHLA-A, sHLA-B, sHLA-C, sHLA-E, sHLA-G, and sHLA-H or at least one of the aforementioned proteins. It is generally preferred that the antibody have a “pan” specificity for HLA-I molecules, so that the pool of peptides bound thereto is as representative as possible of the peptides carried by endogenous sHLA-I of the subject. In particular embodiments, the antibody has specificity for an sHLA-I protein supertype selected from the group consisting of A01; A01 A03; A01 A24; A02 A03; A24; B07; B08; B27; B44; B58; B62, Cw1; Cw2; Cw3; Cw4; Cw5; Cw6; Cw7; Cw8; Cw9(w3); Cw10(w3) and combinations thereof.

Antibodies specific for HLA-I molecules are known in the art and are widely commercially available. For example, monoclonal antibody W6/32 recognizes mature complexed class I molecules, and is directed against a conformational epitope that includes both residue 3 of beta 2-microglobulin and residue 121 of the heavy chain (Ladasky J J, Shum B P, Canavez F, Seuanez H N, Parham P. Residue 3 of beta2-microglobulin affects binding of class I MHC molecules by the W6/32 antibody. Immunogenetics 1999 April; 49(4):312-20).

The enrichment factor, i.e. the concentration of the sHLA-I molecules with peptide ligands bound thereto relative to the other proteins in the pool obtained from step (ii), may be typically at least 1000 relative to the biological fluid sample. The enrichment factor can be, for example, about 10,000, about 100,000 or even higher as compared to the biological fluid sample. In other words, the sHLA-I molecules in the pool are purified by a factor of at least 1000, or at least 10,000, or at least 100,000 relative to the starting material. For example, human plasma contains about 50 mg/ml of protein, of which sHLA constitutes about 0.1 to about 10 μg/ml, i.e. at most, about 0.02% of the total protein. However, in the enriched sHLA-1 fraction obtained according to the invention, the relative concentration or weight percentage of sHLA-1 therein is typically at least 1000 times that of the fluid sample starting material. Determination of the concentration of sHLA-I in a sample or fraction may be carried out by well-known immunological methods, for example ELISA.

The methods of the invention may further comprise a step, designated step (iv), of dissociating the peptide ligands bound to the sHLA-I molecules in the pool obtained in (ii), so as to obtain a pool of peptides. Accordingly, when used, step (iv) is carried out prior to step (iii). In particular embodiments, the operation of dissociating bound sHLA-I molecules from the solid substrate carried out in step (ii) and the operation of dissociating the peptide ligands bound to the sHLA-I molecules carried out in step (iv) are performed in a single operation. The peptides obtained in step (iv) may be further purified away from the cogent sHLA molecules prior to analysis. As is known in the art, purification may involve an operation such as centrifugation and filtration.

The concentration of the peptides in the pool obtained in step (iv) may be typically at least 1000-fold greater than that in the biological fluid sample, and can be, for example, about 10,000-fold greater, about 100,000-fold greater or even a higher fold enrichment as compared to the biological fluid sample.

In particular embodiments, the disease-associated peptide has an amino acid sequence selected from the group consisting of SEQ ID NOS: 1-278 and combinations thereof. Such peptides are disclosed in Example 1 herein to be indicative of malignant hematologic cancers. In particular embodiments, the hematologic cancer is acute myeloid leukemia and the disease-associated peptide has an amino acid sequence selected from the group consisting of SEQ ID NOS: 1-78 and combinations thereof. In particular embodiments, the hematologic cancer is multiple myeloma and the disease-associated peptide has an amino acid sequence selected from the group consisting of SEQ ID NOS: 79-216 and combinations thereof. In particular embodiments, the hematologic cancer is acute lymphoblastic leukemia and the disease-associated peptide has an amino acid sequence selected from the group consisting of SEQ ID NOS: 167-237 and combinations thereof. In particular embodiments, the hematologic cancer is at least one of multiple myeloma, acute myeloid leukemia and acute lymphoblastic leukemia and the disease-associated peptide has an amino acid sequence selected from the group consisting of SEQ ID NOS: 238-276 and combinations thereof.

In particular embodiments of the invention, the HLA-I allele types of the subject are determined. This may, in some embodiments facilitate correlating detection of a particular peptide with disease diagnosis, risk, stage or prognosis. In particular, due to polymorphism in the genes encoding HLA-I molecules, hundreds of different HLA-I allele types exist throughout the human population, resulting in wide diversity. A significant consequence of this diversity is that among individuals having different HLA-I alleles, different peptides are “displayed” on their endogenous HLA-I molecules, or the same peptides may be bound with different affinity, depending on the alleles of the individual.

In accordance with the invention, malignant diseases include for example, hematologic cancers, bladder cancer, bone cancer, breast cancer, cervical cancer, colon cancer, endometrial cancer, gastric cancer, head and neck cancer, hepatic cancer, kidney cancer, lung cancer, melanoma, ovarian cancer, pancreatic cancer, prostate cancer, renal cancer, sarcoma, skin cancer, stomach cancer, testicular cancer and thyroid cancer. Hematologic cancers include for example, multiple myeloma (MM), acute lymphoblastic leukemia (ALL), acute myeloid leukemia (AML), chronic lymphocytic leukemia CLL), chronic myelogenous leukemia (CML), Hodgkin's disease (HD), non-Hodgkin's lymphoma and hairy cell leukemia (HCL). Additional malignant diseases include hepatocellular carcinoma, hematoma, hepatoblastoma, rhabdomyosarcoma, esophageal carcinoma, thyroid carcinoma, ganglioblastoma, fibrosarcoma, myxosarcoma, liposarcoma, chondrosarcoma, osteogenic sarcoma, chordoma, angiosarcoma, endotheliosarcoma, Ewing's tumor, leimyosarcoma, rhabdotheliosarcoma, invasive ductal carcinoma, papillary adenocarcinoma, squamous cell carcinoma, basal cell carcinoma, adenocarcinoma (well differentiated, moderately differentiated, poorly differentiated or undifferentiated), renal cell carcinoma, hypernephroma, hypernephroid adenocarcinoma, bile duct carcinoma, choriocarcinoma, seminoma, embryonal carcinoma, Wilms' tumor, lung carcinoma including small cell, non-small and large cell lung carcinoma, glioma, astrocyoma, medulloblastoma, craniopharyngioma, ependymoma, pinealoma, retinoblastoma, neuroblastoma, and rectal carcinoma.

The invention may be used to facilitate disease staging, or in conjunction with disease staging or classification, for example of hematologic cancers.

For example, acute leukemias, such as AML, are categorized according to the French-American-British (FAB) morphological classification into eight subtypes, termed M0 to M7. In undifferentiated AML (M0), the bone marrow cells show no significant signs of differentiation. In myeloblastic leukemia (M1; with/without minimal cell maturation), the bone marrow cells show some signs of granulocytic differentiation. In myeloblastic leukemia (M2; with cell maturation), the maturation of bone marrow cells is at or beyond the promyelocyte stage and varying amounts of maturing granulocytes may be seen. In promyelocytic leukemia (M3 or M3 variant (M3V)) most cells are abnormal early granulocytes that are between myeloblasts and myelocytes with respect to stage of development and contain many small particles. The cell nucleus may vary in size and shape, and bleeding and blood clotting problems, such as disseminated intravascular coagulation are commonly seen. In myelomonocytic leukemia (M4 or M4 variant with eosinophilia (M4E)), the bone marrow and circulating blood have variable amounts of differentiated granulocytes and monocytes; the proportion of monocytes and promonocytes in the bone marrow is greater than 20% of all nucleated cells. The M4E variant also contains a number of abnormal eosinophils in the bone marrow. In monocytic leukemia (M5), two forms are seen in which the first form is characterized by poorly differentiated monoblasts with lacy-appearing genetic material, and the second differentiated form is characterized by a large population of monoblasts, promonocytes, and monocytes. The proportion of monocytes in the bloodstream may be higher than that in the bone marrow. M5 leukemia may infiltrate the skin and gums, and it has a worse prognosis than other subtypes. Erythroleukemia (M6) is characterized by abnormal red blood cell-forming cells, which make up over half of the nucleated cells in the bone marrow. In megakaryoblastic leukemia (M7) the blast cells appear as immature megakaryocytes or lymphoblasts. M7 leukemia may be distinguished by extensive fibrous tissue deposits (fibrosis) in the bone marrow.

Chronic lymphocytic leukemia (CLL) is classified by one of two cytologic staging systems, known as Rai Classification and Binet Staging, respectively. The Rai Classification divides chronic lymphocytic leukemia into low-, intermediate-, and high-risk categories, which correspond to stages 0, I & II, and III & IV, respectively: Rai Stage 0 patients are low risk and have lymphocytosis, a high lymphocyte count defined as more than 15,000 lymphocytes per cubic millimeter (>15,000/mm3). Rai Stage I patients are intermediate risk and have lymphocytosis plus lymphadenopathy. Rai Stage II patients are also intermediate risk but have lymphocytosis plus an hepatomegaly or splenomegaly, with or without lymphadenopathy. Rai Stage III patients are high-risk and have lymphocytosis plus anemia, a low red blood cell count (hemoglobin<11 g/dL), with or without lymphadenopathy, hepatomegaly, or splenomegaly. Rai Stage 1V patients are also high-risk but have lymphocytosis plus thrombocytopenia, a low number of blood platelets (<100-103/dL).

Binet Staging classifies CLL according to the number of lymphoid tissues that are involved (i.e., the spleen and the lymph nodes of the neck, groin, and underarms), as well as the presence of anemia or thrombocytopenia. Binet Stage A patients have fewer than three areas of enlarged lymphoid tissue. Enlarged lymph nodes of the neck, underarms, and groin, as well as the spleen, are each considered “one group” whether unilateral (one-sided) or bilateral (on both sides). Binet Stage B patients have more than three areas of enlarged lymphoid tissue. Binet Stage C patients have anemia plus thrombocytopenia (platelets<100-103/dL).

Patients who meet diagnostic criteria for multiple myeloma may be staged according to the International Staging System (ISS) of the International Myeloma Working Group (Greipp P R, San Miguel J, Durie B G, et al. (2005). International staging system for multiple myeloma. J. Clin. Oncol. 23 (15):3412-20). Stage I is characterized by β2-microglobulin (β2M)<3.5 mg/L, albumin>/=3.5 g/dL; Stage II is characterized by β2M<3.5 and albumin<3.5; or β2M>/=3.5 and <5.5; Stage III is characterized by β2M>/=5.5.

The ISS may be considered a prognostic index rather than a true staging system, and thus may preferably be used together with the Durie Salmon Staging System (Durie B G, Salmon S E (1975). A clinical staging system for multiple myeloma. Correlation of measured myeloma cell mass with presenting clinical features, response to treatment and survival. Cancer 36 (3):842-54). Stage I is characterized by all of Hb>10 g/dL; normal calcium; skeletal survey: normal or single plasmacytoma or osteoporosis; serum paraprotein level <5 g/dL if IgG, <3 g/dL if IgA; urinary light chain excretion <4 g/24 h. Stage II is characterized by fulfilling the criteria of neither I nor III. Stage III is characterized by one or more of Hb<8.5 g/dL; high calcium >12 mg/dL; skeletal survey: three or more lytic bone lesions; serum paraprotein >7 g/dL if IgG, >5 g/dL if IgA; urinary light chain excretion >12 g/24 h. Stages I, II, and III of the Durie-Salmon staging system can be further divided into A or B depending on serum creatinine, wherein A is characterized by serum creatinine <2 mg/dL (<177 μmol/L), and B is characterized by serum creatinine >2 mg/dL (>177 μmol/L).

CML is divided into three groups, referred to as “phases”. In the chronic phase, patients have fewer than 5% blasts and promyelocytes in blood and bone marrow samples. Symptoms are relatively mild, and patients usually respond to standard treatments. In the accelerated phase, bone marrow and blood samples have more than 5% but fewer than 30% blasts. Patients often have fever, poor appetite, and weight loss. Symptoms and blood counts are not as responsive to treatments as during the chronic phase. The leukemic cells have new chromosome changes, in addition to the Philadelphia chromosome. In the blast phase (also called acute phase or blast crisis), bone marrow and/or blood samples have more than 30% blasts, which often spread to tissues and organs beyond the bone marrow.

Patients with hairy cell leukemia are sometimes staged based on the presence of anemia and splenomegaly. Stage I is characterized by no or slight anemia and moderate splenomegaly, or moderate anemia and normal size spleen. Stage II is characterized by no or slight anemia and significant splenomegaly, or moderate anemia and moderate splenomegaly, or severe anemia and normal size spleen. Stage III is characterized by moderate anemia and significant splenomegaly, or severe anemia and moderate or significant splenomegaly.

Autoimmune diseases include for example, multiple sclerosis, arthritis, psoriatic spondylitis, spondyloarthropathy, celiac disease, systemic lupus erythematosus (SLE), myasthenia gravis, inclusion body myositis, Sjögren's syndrome, narcolepsy, diabetes, Crohn's Disease and Behçet's syndrome.

Infectious diseases include for example bacterial, parasitic and viral diseases.

### Immunoaffinity Chromatography

The methods of the invention comprise processing of a biological fluid sample so as to obtain an enriched pool of endogenous sHLA-I molecules. This is conveniently and preferably carried out by affinity chromatography using an antibody (i.e. immunoaffinity chromatography) having specificity for sHLA-I. The antibody is preferably a monoclonal antibody or an antigen binding fragment thereof. As is known in the art, the antibody is immobilized onto a solid substrate, usually a bead in a column, and the sample mixture is contacted with the solid substrate so as to allow specific antigen-antibody binding. After a number of washing steps to remove non-specifically bound material, the material specifically bound to the antibody is “eluted” or desorbed by passage thereupon of an eluting buffer e.g. having high salt and/or low pH.

The solid support or substrate to which the antibody is affixed may be any suitable material as is known in the art, including agarose, sepharose, silica, or collodion charcoal. Methods for affixing proteins to such solid supports are well known in the art, described for example in Ostrove (1990), Methods in Enzymology, 182: 357-371. The support or substrate together with the affixed antibody is also termed an “adsorbant”. According to the current invention, the solid substrate comprising an antibody having specificity for sHLA-I is also termed an “anti-HLA-I adsorbant”.

Suitable buffers for immunoaffinity chromatography include, but are not limited to, phosphate buffers, Tris buffers, acetate buffers, and/or citrate buffers. Suitable salts include, but are not limited to, sodium chloride, potassium chloride, ammonium chloride, sodium acetate, potassium acetate, ammonium acetate, calcium salts, and/or magnesium salts. For example, the solution may comprise Tris at concentrations between about 5 and 100 mM and sodium chloride at concentrations between about 50 and 250 mM. After loading, the adsorbent can be washed with more of the same solution. The protein can be eluted using a solution that interferes with the specific antibody antigen binding. This solution may include a chaotropic agent, such as guanidinium, an agent that can either increase or decrease pH, and/or a salt. This solution may include for example, acetic acid, trifluoroacetic acid, glycine, or citric acid. Elution may be effected by lowering the pH. For example, the pH can be lowered to about 4.5 or less, such as pH 3.0. Alternatively, the pH can be increased, typically to above about 8.5. Solutions appropriate to effect such elutions may comprise for example, Tris or sodium carbonate. Other methods of elution are also available. Protocols for immunoaffinity chromatography are well known in the art, as disclosed for example in Miller and Stone (1978), J. Immunol. Methods 24(1-2): 111-125. Conditions for binding and eluting can be easily optimized by those skilled in the art.

According to a currently preferred embodiment of the current invention, the step of eluting the sHLA-I molecules which are bound to the anti-HLA-I adsorbant may also serve to dissociate the peptides from their cogent sHLA-I molecules. That is, steps (ii) and (iv) of the methods disclosed herein may be performed in a single operation, such as contacting the anti-HLA-I adsorbant with a solution of low pH, such as a buffer solution adjusted to pH 3.0.

### Antibodies

The term “antibody” is used in the broadest sense and specifically covers monoclonal antibodies (including full length monoclonal antibodies), polyclonal antibodies, multispecific antibodies (e.g., bispecific antibodies), and antibody fragments so long as they retain, or are modified to comprise, antigen binding capacity.

“Antibody fragments” comprise a portion of a full length antibody, generally the antigen binding or variable region thereof. Examples of antibody fragments include Fab, Fab′, F(ab′)₂, and Fv fragments; single-chain antibody molecules; diabodies; linear antibodies; and multispecific antibodies formed from antibody fragments.

The term “monoclonal antibody” as used herein refers to an antibody obtained from a population of substantially homogeneous antibodies, i.e., the individual antibodies comprising the population are identical except for possible naturally occurring mutations that may be present in minor amounts. Monoclonal antibodies are highly specific, being directed against a single antigenic site. Furthermore, in contrast to conventional (polyclonal) antibody preparations which typically include different antibodies directed against different determinants (epitopes), each monoclonal antibody is directed against a single determinant on the antigen. The modifier “monoclonal” indicates the character of the antibody as being obtained from a substantially homogeneous population of antibodies, and is not to be construed as requiring production of the antibody by any particular method. For example, monoclonal antibodies may be made by the hybridoma method first described by Kohler et al., Nature 256:495 (1975), or may be made by recombinant DNA methods (see, e.g., U.S. Pat. No. 4,816,567). The “monoclonal antibodies” may also be isolated from phage antibody libraries using techniques such as those described in Clackson et al., Nature 352:624-628 (1991) and Marks et al., J. Mol. Biol. 222:581-597 (1991).

The monoclonal antibodies herein specifically include “chimeric” antibodies (immunoglobulins) in which a portion of the heavy and/or light chain is identical with or homologous to corresponding sequences in antibodies derived from a particular species or belonging to a particular antibody class or subclass, while the remainder of the chain(s) is identical with or homologous to corresponding sequences in antibodies derived from another species or belonging to another antibody class or subclass, as well as fragments of such antibodies, so long as they exhibit the desired biological activity (U.S. Pat. No. 4,816,567; and Morrison et al., Proc. Natl. Acad. Sci. USA 81:6851-6855 (1984)).

Antibody fragments may be derived via proteolytic digestion of intact antibodies (see, e.g., Morimoto et al. Journal of Biochemical and Biophysical Methods 24:107-117 (1992) and Brennan et al., Science, 229:81 (1985)), or by direct production in recombinant host cells. For example, antibody fragments can be isolated from antibody phage libraries. Alternatively, Fab′-SH fragments can be directly recovered from E. coli and chemically coupled to form F(ab′)₂ fragments (Carter et al., Bio/Technology 10:163-167 (1992)). According to another approach, F(ab′)₂ fragments can be isolated directly from recombinant host cell culture. Other techniques for the production of antibody fragments will be apparent to the skilled practitioner. In other embodiments, the antibody can be a single chain Fv fragment (scFv), as disclosed in WO 93/16185.

The antibodies used for immunoaffinity separation of sHLA-I in the present invention are directed against any soluble HLA-I gene product. HLA-I gene products include for example HLA-A, HLA-B, HLA-C, HLA-D, HLA-E, HLA-F, HLA-H, HLA-J, HLA-K, HLA-L, HLA-P, HLA-T, HLA-U, HLA-V, HLA-W and HLA-X, and any of their polymorphic alleles. Further, the antibody used may be directed to a particular HLA-I supertype, including for example A01; A01 A03; A01 A24; A02 A03; A24; B07; B08; B27; B44; B58; B62, Cw1; Cw2; Cw3; Cw4; Cw5; Cw6; Cw7; Cw8; Cw9(w3); Cw10(w3) and combinations thereof.

Comprehensive information on HLA-I gene products and alleles thereof may be found for example, in Holdsworth et al (2009) The HLA dictionary 2008: a summary of HLA-A, -B, -C, -DRB1/3/4/5, and -DQB1 alleles and their association with serologically defined HLA-A, -B, -C, -DR, and -DQ antigens Tissue Antigens 73(2):95-170 (Wiley); Robinson et al (2009) The IMGT/HLA Database Nucl Acids Res 34:D1013-D1017; Sidney et al BMC Immunol. 2008; 9:1 and the IMGT/HLA database (http://www.ebi.ac.uk/imgt/hla) Methods for purifying sHLA-I molecules and production of antibodies directed against them are well within the skill of one of ordinary skill in the art. In particular embodiments of the methods disclosed herein, it may be of benefit to determine the HLA-I tissue type of the subject. Accordingly, the antibody used for immunoaffinity chromatography may be selected in accordance with a particular HLA-I allelic variant or supertype of the subject.

### Peptide Detection

The methods of the invention comprise detection of disease-associated peptides associated with a pool of endogenous sHLA molecules obtained from a biological sample. The detection may be carried out by any method known in the art, including without limitation mass spectrometry (MS), immunoassays, hybridization, enzyme assays, array-type binding assays, and combinations thereof. The detection may be quantitative or qualitative. Suitable techniques include for example, LC-MS, GC-MS, chromatographic separations, 2-D gel separations, binding assays (e.g., immunoassays), competitive inhibition assays, and so on. It is within the ability of one of ordinary skill in the art to determine which method would be most appropriate for measuring a specific peptide or group of peptides. Regardless of the method selected, it is important that the measurements be reproducible.

A number of mass spectrometric methods are available. Preferably, the mass spectroscopy instrument used is one which provides a high mass accuracy such as an hybrid ion trap-Orbitrap mass spectrometer (e.g. LTQ-Orbitrap™XL), disclosed for example in Makarov Anal Chem 2000; 72(6):1156-62; and in Hu et al., J Mass Spectrom 2005; 40:430-443, or another mass spectrometer system that combines sequencing capabilities with mass analyzer having sufficient resolution, as is known in the art. For example, an LTQ-FTMS instrument may be connected to a reversed phase-high performance liquid chromatography system with a nanospray ionization source. Other available systems comprise matrix-assisted laser desorption ionization (MALDI) and time-of-flight (TOF) measurements. The mass accuracy of the mass spectroscopy instrument should be such that it enables identification of multiply charged peptides and determination of their charge state, thus enabling confident identification of the protein precursors from which the peptides are derived.

For peptide analysis, quantification can be based on derivatization in combination with isotopic labeling, referred to as isotope coded affinity tags (“ICAT”). In this method, a specific amino acid in two samples is differentially and isotopically labeled and subsequently separated from peptide background by solid phase capture, wash and release. The intensities of the molecules from the two sources with different isotopic labels can then be accurately quantified with respect to one another. Quantification can also be based on the isotope dilution method by spiking in an isotopically labeled peptide or protein analogous to those being measured. Furthermore, quantification can also be determined without isotopic standards using the direct intensity of the analyte comparing with another measurement of a standard in a similar matrix.

Preferably, the peptides are measured using mass spectrometry in connection with a separation technology, such as liquid chromatography-mass spectrometry (LC-MS). For example, coupling reversed-phase liquid chromatography to high resolution, high mass accuracy electrospray ionization (ESI) time-of-flight (TOF) mass spectrometry allows spectral intensity measurement of a large number of biomolecules from a relatively small amount of any complex biological material.

Analysis by liquid chromatography-mass spectrometry produces a mass intensity spectrum, the peaks of which represent various components of the sample, each component having a characteristic mass-to-charge ratio (m/z) and retention time (RT). The presence of a peak with the m/z and RT of a particular peptide sequence indicates that the peptide is present. The peak representing a peptide may be compared to a corresponding peak from another spectrum (e.g., from a control sample) to obtain a relative measurement. Any normalization technique in the art (e.g., an internal standard) may be used when a quantitative measurement is desired. “Deconvoluting” software is available to separate overlapping peaks. The retention time depends to some degree on the conditions employed in performing the liquid chromatography separation.

In other embodiments, the peptides may be detected using a standard immunoassay, such as sandwiched ELISA using matched antibody pairs and chemiluminescent detection. Commercially available or custom monoclonal or polyclonal antibodies directed against peptide of interest are typically used. However, the assay can be adapted for use with other reagents that specifically bind to the target peptides. Standard protocols and data analysis are used to determine the peptide concentrations from the assay data.

Immunoassays are carried out using a suitable solid substrate or support, including for example, beads, microspheres, membranes and microtiter plates, typically made of glass, plastic, polysaccharides, nylon or nitrocellulose. Microtiter plates are especially convenient because a large number of assays can be carried out simultaneously, using small amounts of reagents and samples.

Before adding peptide pools or fractions thereof, the non-specific binding sites on the solid substrate i.e. those not occupied by the peptide binding reagent(s), are generally blocked with non-interfering proteins such as bovine serum albumin, casein, gelatin, and the like. Samples, fractions or aliquots thereof are then added to separately assayable supports (for example, separate wells of a microtiter plate) containing support-bound anti-peptide antibodies or other specific binding reagents. Preferably, each sample and standard will be added to multiple wells so that mean values can be obtained for each. After incubation, the insoluble support is washed of non-bound peptides and a solution containing specific second receptor is applied. The receptor may be any compound that binds the anti-peptide antibodies, and is usually a different antibody (monoclonal or polyclonal) specific for the immunoglobulin Fc region or a species specific antibody directed against the species in which the first antibody was generated.

Antibodies may be labeled to facilitate direct or indirect quantification of binding. Examples of labels that permit direct measurement include radiolabels, such as ³H or ¹²⁵I, fluorescent labels, dyes, beads, chemilumninescers, colloidal particles, and the like, as are known in the art. Examples of labels which permit indirect measurement of binding include enzymes where the substrate may provide for a colored or fluorescent product. Examples of suitable enzymes include horseradish peroxidase, alkaline phosphatase, malate dehydrogenase, luciferase and the like. Examples of suitable fluorescent labels include FITC, rhodamine and lanthanide phosphors.

Alternatively, the second receptor may be unlabeled. In this case, a labeled second receptor-specific compound is employed which binds to the bound second receptor. Such a second receptor-specific compound can be labeled, in any manner as described above. It is possible to select such compounds such that multiple compounds bind each molecule of bound second receptor. Examples of second receptor/second receptor-specific molecule pairs include antibody/anti-antibody and avidin (or streptavidin)/biotin. Since the resultant signal is thus amplified, this technique may be advantageous for detection of low abundance peptides. An example is the use of a labeled antibody specific to the second receptor. More specifically, where the second receptor is a rabbit anti-allotypic antibody, an antibody directed against the constant region of rabbit antibodies provides a suitable second receptor specific molecule. The anti-immunoglobulin will usually come from any source other than human, such as mouse, or bovine antibody.

After the second receptor or second receptor-conjugate has bound, the insoluble support is again washed free of non-specifically bound second receptor, and the signal produced by the bound conjugate is detected by conventional means. Where an enzyme conjugate is used, an appropriate enzyme substrate is provided so a detectable product is formed. For example, when a peroxidase is the enzyme conjugate, a preferred substrate combination is H₂O₂ and O-phenylenediamine which yields a colored product under appropriate reaction conditions. The product may be measured by spectrophotometric light absorbance at 490-495 nm. Appropriate substrates for other enzyme conjugates, reaction conditions and means of detecting reaction products are known to those skilled in the art.

Peptides may be detected using an array-based binding assay system. Such an array-based system may incorporate an immunoassay as described above. Generally, the solid substrate used for the array comprises a plurality of binding reagents attached to the substrate, wherein each binding reagent has specificity for a different disease-associated peptide amino acid sequence. The peptide “set” for which the array is predetermined to specifically bind is characteristic of a particular disease. The binding reagents, usually proteins, are immobilized onto the substrate surface, preferably in a spatially addressable manner. The binding reagents may be antibodies, antibody fragments or TCR-like molecules. In particular, TCR-like molecules, such as TCR-like antibodies, may be used for recognition of particular peptides which are in association with their cogent sHLA-I molecules when they are applied to the array. TCR-like antibodies, including design and production thereof, are disclosed for example, in U.S. Patent Application Publication Nos. 2009/0226474; 2009/0304679; 2007/0196369; 2007/0092530 and 2005/0255101; Chames et al., (2002) J. Immunol. 169:1110-1118; Denkberg and Reiter (2006) Autoimmunity Rev 5:252-257; and Stewart-Jones et al., (2009) Proc Natl Acad Sci USA 106(14):5784-8.

The nature and geometry of the solid substrate will depend upon a variety of factors, including, among others, the type of array (e.g., one-dimensional, two-dimensional or three-dimensional). Generally, the surface can be composed of any material which will permit immobilization of the binding reagents and which will not substantially degrade under the conditions used in the applications of the array.

The solid substrate used for the array may be in the form of beads, particles or sheets, and may be permeable or impermeable, depending on the type of array, wherein the surface is coated with a suitable material enabling binding of the binding reagents at high affinity. For example, for linear or three-dimensional arrays the surface may be in the form of beads or particles, fibers (such as glass wool or other glass or plastic fibers) or glass or plastic capillary tubes. For two-dimensional arrays, the solid surface may be in the form of plastic, micromachined chips, membranes, slides, plates or sheets in which at least one surface is substantially flat, wherein these surfaces may comprise glass, plastic, silicon, low cross-linked and high cross-linked polystyrene, silica gel, polyamide, and the like.

Fluorescence tagged beads are also an addressable (liquid) array in which each bead is tagged with a different set of fluorescent colors and bound with an antibody, a TCR or a TCR-like molecule. The binding of specific sHLA-peptide complexes to such beads or array are detected with devices such as fluorescence scanners for arrays or FACS for beads.

The arrays used for the present invention may be of any desired size. The upper and lower limits on the size of the array are determined solely by the practical considerations of resolution, size of molecules expressed at each address and the like.

Either a population of discrete proteins is employed to form the array, such that each address presents a different molecule, or a single or a few addresses are employed with a similar protein. In many applications, redundancies in the spots are desirable for the purposes of acting as internal controls.

Technologies for the deposition of droplets containing protein binding reagents onto a suitable solid surface are known in the art. An ink jet printing technology for deposition of small droplets while avoiding overlap or splatter is disclosed in U.S. Pat. No. 5,449,754.

In order to conduct array or microarray assays, the sHLA-I molecule pool comprising bound peptides or the isolated peptide pool is added to the array comprising a coated surface containing the anchored binding reagents. Following contact, the array is optionally washed, typically under conditions such that any complexes formed will remain immobilized on the solid surface and unbound material will be removed.

The detection of complexes anchored on the solid surface can be accomplished in a number of ways. In some embodiments, the non-immobilized sample is pre-labeled, and the detection is directed for label immobilized on the surface indicating that complexes were formed. In other embodiments, the non-immobilized sample is not pre-labeled, an indirect label can be used to detect complexes anchored on the surface; e.g., using a labeled antibody specific for the previously non-immobilized sample (the antibody, in turn, may be directly labeled or indirectly labeled with a labeled anti-Ig antibody). In another preferred embodiment, the immobilized molecules of the microarray are labeled, the array can be scanned or otherwise analyzed for detectable assay signal, and the signal from each labeled spot, or alternatively from all spots, quantified.

An important feature of a direct detection of the array is the presence of an amount of a label at each position within the array that is proportional to the amount of molecule immobilized at that particular spot. Thus, it is important that the efficiencies of the coupling reactions which are used to immobilize the labeled molecules are substantially similar.

Virtually any label that produces a detectable, quantifiable signal and that is capable of being attached to an immobilized binding reagent on a substrate can be used in conjunction with the array of the invention. Suitable labels include, by way of example and not limitation, radioisotopes, fluorophores, chromophores, chemiluminescent moieties, etc. In particular embodiment, the array-based assay system comprises detection of a fluorescent signal, a chemiluminescent signal or a plasmon resonance signal.

Preferably, the position of the label will not interfere with interaction between a desired sample and the immobilized molecules and with the detection in case of an interaction between the desired sample and an immobilized molecule of the array. Suitable methods of making labeled molecules are well known in the art.

In the case where each spot in the array contains an amount of a label or “tracer” proportional to the amount of molecules immobilized at the particular spot, the signals obtained from the arrays of the invention can be normalized. As a consequence, signal intensities from spots within a single array, or across multiple arrays, can be directly compared. A normalized signal of a particular spot may be defined by (Iₜ−Iₒ)/Iₒ, where Iₜ is the intensity of the signal of the spot after contacting with a sample of interest and Iₒ is the intensity of the background signal of the spot before contacting with a sample of interest.

Various methods and devices for detection and analysis of the array are known in the art. Practically, any imaging system that is capable of detecting with a resolution appropriate to the size of the array features can be utilized. For example, a method for screening an array of proteins for interactions with a fluid sample is disclosed in U.S. Pat. No. 6,475,809. Imaging apparatus may be selected, for example, from ScanArray 4000 (General Scanning), Biochip Imager (Hewlett Packard), GMS 418 Array Scanner (Genetic Microsystems), GeneTAC 1000 (Genomic Solutions), Chip Reader (Virtek). Phosphorimager systems are available for detecting radiolabels, e.g. Cyclone (Packard Instrument Co.) and BAS-5000 (Fujifilm).

### Kits

The invention further provides a kit comprising a first solid substrate comprising an immobilized antibody having specificity for sHLA-I, and a second solid substrate comprising at least one binding reagent having specificity for at least one disease-associated peptide amino acid sequence. In currently preferred embodiments, the second solid substrate comprises a plurality of different binding reagents, wherein the different binding reagents are directed to different peptide amino acid sequences. The peptide “set” which is bound by the plurality of binding reagents affixed to the second solid substrate is characteristic of a particular disease. The second solid substrate comprising at least one binding reagent may be an element of an immunoassay, such as ELISA, as hereinbefore described. Alternately, or in addition, the second solid substrate comprising different binding reagents may be an array-based binding assay system as hereinbefore described. The binding reagent(s) may be antibodies, antibody fragments or TCR-like molecules, such as TCR-like antibodies. In particular embodiments, the immunoassay comprises ELISA. In particular embodiments, the immunoassay or the array-based binding assay system comprises detection of a signal such as a fluorescent signal, a chemiluminescent signal or a plasmon resonance signal. In particular embodiments, the peptide is selected from the group consisting of SEQ ID NOS: 1-276

Peptides

Preferred peptides for use in the methods and compositions of the invention include those having the amino acid sequences of SEQ ID NOS: 1-276.

Peptides for use in the compositions of the invention may further comprise a modification, on the condition that such modified peptide(s) retain biological activity of the original sHLA-I binding peptides disclosed herein. Such modified peptides may be considered to be derivatives or functional variants of the sHLA-I binding peptides.

Several HLA-related databases contain extensive information on HLA-I binding peptides. Such databases include SYFPEITHI (Rammensee et al Immunogenetics. 1999; 50:213-9), HLA. Ligand (Sathiamurthy et al Tissue Antigens. 2003; 61:12-9), FIMM (Schonbach et al Nucleic Acids Res. 2002; 30:226-9) and MHCBN Bhasin et al Bioinformatics. 2003; 19:665-6).

The terms “derivative” and “functional variant” are used interchangeably herein to refer to a peptide which contains one or more modifications to the primary amino acid sequence of an sHLA-I binding peptide and retains its sHLA-I binding properties. Modifications are desired, for example, to 1) enhance a property of the peptide, such as increased stability within a multimeric complex and/or more efficient presentation to T cells; 2) provide a novel activity or property to the peptide, such as addition of an antigenic epitope or addition of a detectable moiety; 3) provide a different amino acid sequence that produces the same or similar immunostimulatory properties, or 4) improve the pharmacological characteristics of the immunogenic composition.

Modifications to peptides can be made to nucleic acids which encode the peptides, and can include deletions, point mutations, truncations, amino acid substitutions and additions of amino acids. Alternatively, modifications can be made directly to the peptide, such as by glycosylation, side chain oxidation, phosphorylation, cleavage, addition of a linker molecule, addition of a detectable moiety, such as biotin, addition of a fatty acid, amino acid substitution and the like.

Amino acid substitution to produce peptide functional variants preferably involves conservative amino acid substitution i.e., replacing one amino acid residue with another that is biologically and/or chemically similar, e.g., a hydrophobic residue for another, or a polar residue for another. Examples of conservative substitutions of amino acids include substitutions made amongst amino acids within the following groups: (a) Met, Ile, Leu, Val; (b) Phe, Tyr, Trp; (c) Lys, Arg, His; (d) Ala, Gly; (e) Ser, Thr; (f) Gln, Asn; and (g) Glu, Asp. The peptides of the present invention can be prepared by any suitable means, such as synthetically using standard peptide synthesis chemistry or by using recombinant DNA technology.

The peptides may be modified so as to enhance their immunostimulatory activity, such that the modified peptides have immunostimulatory activity greater than a peptide of the wild-type sequence. Alternately, peptide modifications may serve to increase their binding affinity to HLA-I, and thus increase the clinical efficacy of a complex as described herein. Generally, any substitutions, additions or deletions between epitopic and/or conformationally important residues will employ amino acids or moieties chosen to avoid stearic and charge interference that might disrupt binding.

Modifications also encompass fusion proteins comprising all or part of a peptide amino acid sequence with a related or unrelated protein or polypeptide.

Additional amino acids can be added to the termini of a peptide to provide for ease of linking peptides one to another, or for coupling a peptide to a multimeric complex. Addition of amino acids may also be used for modifying the physical or chemical properties of the peptide and/or multimeric complex. Suitable amino acids, such as tyrosine, cysteine, lysine, glutamic or aspartic acid, can be introduced at the C- or N-terminus of the peptide. In addition, the peptide can differ from the natural sequence by being modified for example, by N-terminal acylation, N-terminal amidation, or C-terminal amidation. In some instances these modifications may provide sites for linking to a support or other molecule, thereby providing a linker function.

Modifications also encompass introduction of one or more non-natural amino acids, introduced so as to render a peptide non-hydrolyzable or less susceptible to hydrolysis, as compared to the original peptide. To provide such peptides, one may select one or more modified HLA-I binding peptides from a library of non-hydrolyzable peptides, such as peptides containing one or more D-amino acids or peptides containing one or more non-hydrolyzable peptide bonds linking amino acids. Alternatively, one can select peptides which have optimal immunostimulatory properties e.g. in inducing CD8⁺ T lymphocytes, and then modify such peptides as necessary to reduce the potential for hydrolysis by proteases. For example, to determine the susceptibility to proteolytic cleavage, peptides may be labeled and incubated with cell extracts or purified proteases and then isolated to determine which peptide bonds are susceptible to proteolysis. Alternatively, potentially susceptible peptide bonds can be identified by comparing the amino acid sequence of a peptide with the known cleavage site specificity of a panel of proteases. Based on the results of such assays, individual peptide bonds which are susceptible to proteolysis can be replaced with non-hydrolyzable peptide bonds by in vitro synthesis of the peptide.

Non-hydrolyzable peptide bonds are known in the art, along with procedures for synthesis of peptides containing such bonds. Non-hydrolyzable bonds include, but are not limited to, -psi[CH₂NH]-reduced amide peptide bonds, -psi[COCH₂]-ketomethylene peptide bonds, -psi[CH(CN)NH]-(cyanomethylene)amino peptide bonds, -psi [CH₂CH(OH)]hydroxyethylene peptide bonds, -psi[CH₂O]-peptide bonds, and -psi[CH₂S]-thiomethylene peptide bonds.

Modifications also encompass peptides that have conjugated thereto a substance, such as a radioactive moiety, an enzyme, a fluorescent moiety, a solid matrix, a carrier, and a CTL epitope. The substance can be conjugated to the peptide at any suitable position, including the N and C termini and points in between, depending on the availability of appropriate reactive groups in the side chains of the constituent amino acids of the peptide of interest. Additionally, the substance can be conjugated directly to the peptide or indirectly by way of a linker. Radiolabels include ³H, ¹⁴C, ³²P, ³⁵S, ¹²⁵I, and other suitable radioactive moieties for use in various radioimmunoassays and the like. Fluorescent moieties include fluorescein, rhodamine, and other suitable fluorescent labels for use in fluorescent assays and the like. Enzymes include alkaline phosphatase, Bir A and other suitable enzymes useful for any suitable purpose, including as a marker in an assay procedure. Carriers include immunogenic lipids, proteins, and other suitable compounds, such as a liposome or bovine serum albumin.

Peptides for use in the compositions of the invention can be prepared using any suitable means. Because of their relatively short size (generally less than 20 amino acids), the peptides can be synthesized in solution or on a solid support in accordance with conventional peptide synthesis techniques. Various automatic synthesizers are commercially available (for example, from Applied Biosystems) and can be used in accordance with known protocols (see, for example, Stewart and Young (1984) Solid Phase Peptide Synthesis, 2nd ed., Pierce Chemical Co.; Tam et al. (1983) J. Am. Chem. Soc. 105:6442; Merrifield (1986) Science 232:341-347).

Alternatively, recombinant DNA technology may be employed, wherein a nucleotide sequence that encodes a peptide of interest is inserted into an expression vector, transformed or transfected into a suitable host cell and cultivated under conditions suitable for expression. These procedures are generally known in the art, as described generally in Sambrook et al. (2001) Molecular Cloning, A Laboratory Manual 3rd ed. Cold Spring Harbor Press, Cold Spring Harbor, N.Y., and Ausubel et al., eds. (1987) Current Protocols in Molecular Biology John Wiley and Sons, Inc., N.Y., and U.S. Pat. Nos. 4,237,224, 4,273,875, 4,431,739, 4,363,877 and 4,428,941.

As the coding sequence for peptides of the length contemplated herein can be synthesized by chemical techniques, for example, the phosphotriester method of Matteucci et al., J. Am. Chem. Soc., 103, 3185 (1981), modification can be made simply by substituting the appropriate base(s) for those encoding the native peptide sequence. The coding sequence can then be provided with appropriate linkers and ligated into expression vectors commonly available in the art, and the vectors used to transform suitable hosts to produce the desired fusion protein. For expression of the fusion proteins, the coding sequence will be provided with operably linked start and stop codons, promoter and terminator regions and usually a replication system to provide an expression vector for expression in a suitable cellular host. For example, promoter sequences compatible with bacterial hosts are provided in plasmids containing convenient restriction sites for insertion of the desired coding sequence. The resulting expression vectors are transformed into suitable bacterial hosts. Yeast or mammalian cell hosts may also be used, employing suitable vectors and control sequences.

In addition, peptides produced by recombinant methods as a fusion to proteins that are one of a specific binding pair, enable purification of the fusion protein by means of affinity reagents, followed by proteolytic cleavage, usually at an engineered site to yield the desired peptide (see for example Driscoll et al. (1993) J. Mol. Bio. 232:342-350).

### Immunogenic Compositions

The immunogenic compositions comprise at least one pharmaceutically acceptable adjuvant carrier or diluent. Pharmaceutically acceptable adjuvants include but are not limited to vegetable oils or emulsions thereof, surface active substances, e.g., hexadecylamin, octadecyl amino acid esters, octadecylamine, lysolecithin, dimethyldioctadecylammonium bromide, N,N-dicoctadecyl-N′—N′ bis(2-hydroxyethyl-propane diamine), methoxyhexadecylglycerol, and pluronic polyols; polyamines, e.g., pyran, dextransulfate, poly. IC, carbopol; peptides, e.g., muramyl dipeptide, dimethylglycine, tuftsin; immune stimulating complexes; oil emulsions (including, but not limited to, oil-in-water emulsions having oil droplets in the submicron range, such as those disclosed by U.S. Pat. Nos. 5,961,970; 4,073,943 and 4,168,308); liposaccharides such as MPL® and mineral gels. The peptides can also be incorporated into liposomes, cochleates, biodegradable polymers such as poly-lactide, poly-glycolide and poly-lactide-co-glycolides, or ISCOMS (immunostimulating complexes), and supplementary active ingredients may also be employed.

Herein the term “excipient” refers to an inert substance added to a pharmaceutical composition to further facilitate administration of a compound. Examples, without limitation, of excipients include calcium carbonate, calcium phosphate, various sugars and types of starch, cellulose derivatives, gelatin, vegetable oils and polyethylene glycols. Pharmaceutical compositions may also include one or more additional active ingredients.

Pharmaceutical compositions suitable for use in context of the present invention include compositions wherein the active ingredients are contained in an amount effective to achieve the intended purpose. All formulations for administration should be in dosages suitable for the chosen route of administration. More specifically, a “therapeutically effective” dose means an amount of a compound effective to prevent, alleviate or ameliorate symptoms of a disease of the subject being treated. Determination of a therapeutically effective amount is well within the capability of those skilled in the art, especially in light of the detailed disclosure provided herein.

Toxicity and therapeutic efficacy of the compositions described herein can be determined by standard pharmaceutical procedures in cell cultures or experimental animals, e.g., by determining the IC₅₀ (the concentration which provides 50% inhibition) and the LD₅₀ (lethal dose causing death in 50% of the tested animals) for a subject compound. The data obtained from these cell culture assays and animal studies can be used in formulating a range of dosage for use in human. The dosage may vary depending upon the dosage form employed and the route of administration utilized. The exact formulation, route of administration and dosage can be chosen by the individual physician in view of the patient's condition. Depending on the severity and responsiveness of the condition to be treated, dosing can also be a single administration of a slow release composition, with course of treatment lasting from several days to several weeks or until cure is effected or diminution of the disease state is achieved. The amount of a composition to be administered will, of course, be dependent on the subject being treated, the severity of the affliction, the manner of administration, the judgment of the prescribing physician, and all other relevant factors.

The immunogenic composition may comprise the peptide in single copies, but may preferably comprise multiple copies, for example as a multimeric complex, conjugated to the surface of antigen presenting cells or to a non-immunogeneic carrier. Peptide loaded HLA class I molecules conjugated to APCs are described, for example, in U.S. Pat. No. 6,248,564. Cells derived from the subject with cancer may be conjugated in vitro to the peptides or peptide complexes comprising the tumor peptide antigens of interest. The cells used are preferably APCs which can provide the requisite costimulatory signals for inducing an effective T cell response. Sources of APCs include T and B cells from peripheral blood lymphocytes, macrophages/monocytes, and dendritic cells. The conjugates are then introduced back into the subject. Such an immunization strategy allows the control of epitope density and circumvents a variety of problems associated with classical vaccination strategies. For example, unlike traditional peptide vaccines, the peptides embedded in multimeric complexes are protected from rapid enzymatic degradation or intracellular processing.

The immunogenic composition can be administered to a human or animal by a variety of routes, including but not limited to parenteral, intradermal, transdermal (such as by the use of slow release polymers), intramuscular, intraperitoneal, intravenous, subcutaneous, oral and intranasal routes of administration, according to protocols well known in the art. The compositions of the invention are administered in a dose which is suitable to elicit an immune response in said subject. The particular dosage will depend upon the age, weight and medical condition of the subject to be treated, as well as on the identity of the antigen and the method of administration. Suitable doses will be readily determined by the skilled artisan. A preferred dose for human intramuscular, subcutaneous and oral vaccination is between about 50 μg to about 100 mg, preferably between about 200 μg to about 40 mg, and more preferably between about 500 μg to about 10 mg. Adjustment and manipulation of established dosage ranges used with traditional carrier antigens for adaptation to the present vaccinating composition is well within the ability of those skilled in the art.

The pharmaceutical composition of the invention is administered to a subject in need of said treatment in a therapeutically effective amount. According to the present invention, a “therapeutically effective amount” is an amount that when administered to a patient is sufficient to inhibit, preferably to eradicate, or, in other embodiments, to prevent or delay the progression of a disease, preferably a malignant disease. A “therapeutically effective amount” further refers to an amount which, when administered to a subject, results in a substantial increase in the immune response of the subject to the administered immunogen, as described herein.

To formulate peptides for parenteral administration, they are prepared in an injectable dosage form (solution, suspension, emulsion) in association with a pharmaceutically acceptable parenteral vehicle. Examples of such vehicles are water, saline, Ringer's solution, dextrose solution, and Hanks' solution. Non-aqueous vehicles such as fixed oils and ethyl oleate may also be used. The vehicle may contain small amounts of additives, such as substances that enhance isotonicity and chemical stability, e.g. buffers and preservatives. Such vehicles are inherently non-toxic and non-therapeutic. The peptides are preferably formulated in purified form substantially free of aggregates and other proteins at concentrations of about 1-50 mg/ml. Suitable pharmaceutical vehicles and their formulations are described, for example, in Remington's Pharmaceutical Sciences.

Having now generally described the invention, the same will be more readily understood through reference to the following examples, which are provided by way of illustration and are not intended to be limiting of the present invention.

### EXAMPLES

### Example 1

### Isolation of sHLA-I Associated Peptides from Human Diseased and Non-Diseased Subjects and Multiple Myeloma Cell Lines

This example shows that thousands of sHLA-1 associated peptides can be isolated, identified and quantified using small blood samples, forming the basis for sHLA-peptidome diagnostics. The results further demonstrate that the repertoires of identified sHLA-I peptides form unique patterns that represent disease states. These sHLA-peptidomes may serve as diagnosis and prognosis surrogate disease markers, and as well provide valuable sources of tumor peptide antigen candidates for development of cancer immunotherapeutics.

### Materials and Methods

### Cell Lines and Antibodies

The human multiple myeloma (MM) cancer cell lines RPMI8226 and U266 and the anti-HLA class I hybridoma secreting mAb W6/32 were obtained from the American Type Culture Collection. MM cell line L363 was a kind gift from Yoram Reiter. The cells were maintained in RPMI medium with 2 mM L-glutamine, 20% heat-inactivated fetal calf serum and 1% penicillin-streptomycin. The W6/32 monoclonal antibodies were affinity purified from mouse ascites fluid using Protein-A Sepharose (Amersham Biosciences). The monoclonal rabbit anti-human MHC-I antibody EP1359Y (Abeam) and the secondary anti-rabbit alkaline phosphatase antibody (A7359, Sigma) were used for Western blot analyses.

### Patient Characterization

One or more of peripheral blood (PB), bone marrow (BM) and leukopheresis samples were obtained from two multiple myeloma patients (designated MM-1 and MM-2), three acute myeloid leukemia patients (designated AML-1, AML-2 and AML-3) and one acute lymphoblastoid leukemia patient (designated ALL-1), provided by the Department of Hematology and Bone Marrow Transplantation, Rambam Hospital, Israel (Helsinki; Rambam Hospital IRB committee, Study No. 2183). In addition, peripheral blood was obtained from four healthy control subjects. The HLA-I alleles of some of the patients and healthy subjects were determined. The clinical features of the subjects studied are summarized in Table 1.

### Plasma and Cell Collection

Peripheral blood, bone marrow or leukopheresis samples were cleared of cells by centrifugation for 10 min at 1200 g at room temperature. A 1:1000 Protease Inhibitor Cocktail (Sigma) was added to the plasma followed by centrifugation at 4° C. for 10 min at 12,000 g. The cleared plasma samples were stored at −20° C. until use for sHLA purification.

AML and ALL cells from blood samples were layered on a density gradient (Lymphoprep™, Axis-shield, Oslo, Norway), and centrifuged at 1200 g for 20 min at 20° C., the mononucleated cells were collected, washed three times with PBS and frozen at −80° C. until use for membranal HLA class I purification.

TABLE 1
Clinical features of diseased and healthy subjects.

| | | | | | | sHLA/ |
|---|---|---|---|---|---|---|
| | | Disease | Age/ | | Sample | mHLA |
| Subject | Disease | stage | gender | HLA alleles | type | analyzed |
| MM-1 | MM | Stage 3A | 51/M | A02, A11, B51, | PB, BM | sHLA |
| | | | | B52, Cw02, | | |
| | | | | Cw12 | | |
| MM-2 | MM | Stage 3A | 38/M | | PB, BM | sHLA |
| AML-1 | AML | 90-100% | 46/F | A03, A03, B35, | Leukopheresis | sHLA |
| | | infiltration | | B27, Cw04, | | mHLA |
| | | of | | Cw1502 | | |
| | | nucleated | | | | |
| | | cells | | | | |
| AML-2 | AML | 90-100% | 61/M | A83, A26, | PB | sHLA |
| | | infiltration | | Cw12, Cw17 | | |
| | | of | | | | |
| | | nucleated | | | | |
| | | cells | | | | |
| AML-3 | AML | 90-100% | 64/M | A03, A30, B07, | PB | sHLA |
| | | infiltration | | B44, Cw0507 | | mHLA |
| | | of | | | | |
| | | nucleated | | | | |
| | | cells | | | | |
| ALL-1 | ALL | 90-100% | 54/M | | PB | sHLA |
| | | infiltration | | | | mHLA |
| | | of | | | | |
| | | nucleated | | | | |
| | | cells | | | | |
| Healthy-1 | | | 44/M | A01, A02, B35, | PB | sHLA |
| | | | | B35, Cw04, | | |
| | | | | Cw04 | | |
| Healthy-2 | | | 58/F | | PB | sHLA |
| Healthy-3 | | | 33/M | | PB | sHLA |
| Healthy-4 | History | | 37/F | A24, A68, B22, | PB, BM | sHLA |
| | of AML | | | B49, Cw01, | | |
| | | | | Cw07 | | |

### Affinity Purification of HLA Molecules

For purification of mHLA-I, cells were first lysed with 0.25% sodium deoxycholate, 0.2 mM iodoacetamide, 1 mM EDTA, 1:200 Protease Inhibitors Cocktail (Sigma), 1 mM PMSF, 1% octyl-β-D glucopyranoside (Sigma) in PBS at 4° C. for 1 hr. The lysate was cleared by 30 min centrifugation at 40,000 g. HLA-I molecules from cleared lysate, growth medium of cultured cells or from fresh human plasma were immunoaffinity purified using mAb W6/32 bound to AminoLink® Agarose (Pierce). The affinity column was washed with ten column volumes of 150 mM NaCl, 20 mM Tris-HCl (Buffer A), followed by ten column volumes of 400 mM NaCl, 20 mM Tris-HCl, ten volumes of Buffer A again, and finally with seven column volumes of 20 mM Tris-HCl, pH 8.0. In some cases 0.25% sodium deoxycholate, 0.2 mM iodoacetamide, 1 mM EDTA, 1:200 Protease Inhibitors Cocktail (Sigma), 1 mM PMSF, 1% octyl-β-D glucopyranoside (Sigma) in PBS was added before the final washing steps to improve the removal of contaminating factors. The sHLA-I molecules were eluted at room temperature by adding 500 μl of 0.1 N acetic acid, adjusted to pH 3.0 or 1% TFA, without adjustment of pH. Small aliquots of each elution fraction were analyzed by SDS-PAGE and by Western blotting to evaluate the yield and purity of the eluted HLA-I.

### Purification of HLA Associated Peptides

Fractions containing the HLA-I molecules were heated to 95° C. for 10 minutes, cooled on ice for 5 minutes, and centrifuged at 14,000 rpm for 1 minute to recover the bound peptides. The denatured protein subunits of the HLA-I molecules were separated from the small peptides by ultra-filtration, through a 3-kDa cutoff Microcon® (Millipore) by centrifugation at 10,000 g. The filters were pre-washed with 0.1 N acetic acid and 10% acetonitrile.

### Peptide Concentration and Purification

Peptide mixtures recovered after ultra-filtration were concentrated by Micro-Tip® reversed-phase columns (C-18, 200 μl, Harvard Apparatus). The C18 tips were washed with 80% acetonitrile in 0.1% trifluoroacetic acid (TFA), equilibrated with 0.1% TFA, and then loaded with the peptide mix. Each tip was then washed by an additional 0.1% TFA volume and the peptides were eluted with 80% acetonitrile in 0.1% TFA. Peptides samples were then concentrated to about 18 μl using vacuum centrifugation.

### Analysis by Capillary Chromatography and Mass Spectrometry

Recovered peptides were analyzed by μLC-MS/MS using an Orbitrap™XL mass spectrometer (Thermo-Fisher) fitted with a capillary HPLC (Eksigent). The peptides were resolved by reversed phase chromatography on 0.075×200 mm fused silica capillaries (J&W) self-packed with Reprosil® C₁₈ (Dr. Maisch GmbH, Germany) [35]. The peptides were eluted at flow rates of 0.25 μl/min, with linear gradients of 5 to 45% acetonitrile and 0.1% formic acid, during 90 minutes, followed by 15 minutes at 95% of acetonitrile and 0.1% formic acid. The most intense seven masses from each full mass spectrum performed in the Orbitrap, with singly, doubly and triply charge states, were selected for fragmentation by CID in the linear ion-trap. The orbitrap mass resolution was set to 60000, collision energy was set to 35.

### Database Searches

Pep-Miner (37) was used for peak-list generation of the μLC-MS/MS data. The peaks were identified using multiple search engines: Pep-Miner, Proteome Discoverer 1.0 SP1 (Thermo) combining the search results of Sequest (Thermo-Fisher) (38) and Mascot (server 2.2, Matrix Science) (39), using the human part of the Uniprot database (http://www.uniprot.org, January 2009) including 20,332 proteins. The search was not limited by enzymatic specificity, and the peptide tolerance was set to 0.01 Da, and the fragment ion tolerance was set to 0.5 Da. Oxidized methionine was searched as a variable modification. Peptides identified were filtered as follows: Pep-Miner score of above 85 and a Mascot score above 20 and a Sequest Xcorr above 2 and delta-CN below 0.1, mass below 1350 Da, and mass accuracy of 0.003 Da. After filtration, the false discovery rate for the HLA peptides was set at 0.05 using the randomized sequence databank as a decoy.

### HLA Peptides Report

The peptide identifications based on the MS/MS data, were combined into a final report, which contained also the fitness score for the consensus binding motifs for each of the HLA alleles, according to www-bimas@bimas.cit.nih.gov (40), the normalization of the retention times of the different MS spectra and the peak area calculations.

The retention times of all the HPLC runs were normalized to a reference run. First, the MS/MS spectra of two runs were clustered by spectrum similarity while all spectra in a resulting cluster are assumed to be derived from the same peptide (37), and only clusters that include at least one spectrum from each run were normalized. Each MS/MS spectrum was mapped to the MS envelope that contained its precursor ion. The retention time of the envelope was used rather than the MS/MS retention time, which is in an arbitrary point along the envelope. Then the two vectors of retention times were normalized using a linear fit.

Peak masses were calibrated using the 445.1200 Da PCM ion (41). Peak envelopes were identified in the three-dimensional MS space (time×mass×intensity). An envelope consisted of three or more peaks that appeared in adjacent MS scans and were close to each other in mass (less than 0.005 Da) was used for calculating the envelop area, which was the sum of intensities of the peaks that were at least 30% as high as the largest peak in the envelope.

Gene ontology analysis was done by the PANTHER Classification System (http://www.pantherdb.org/). For each subject the mass spectrometric analysis with the largest number of identified peptides was selected for this analysis.

### Results

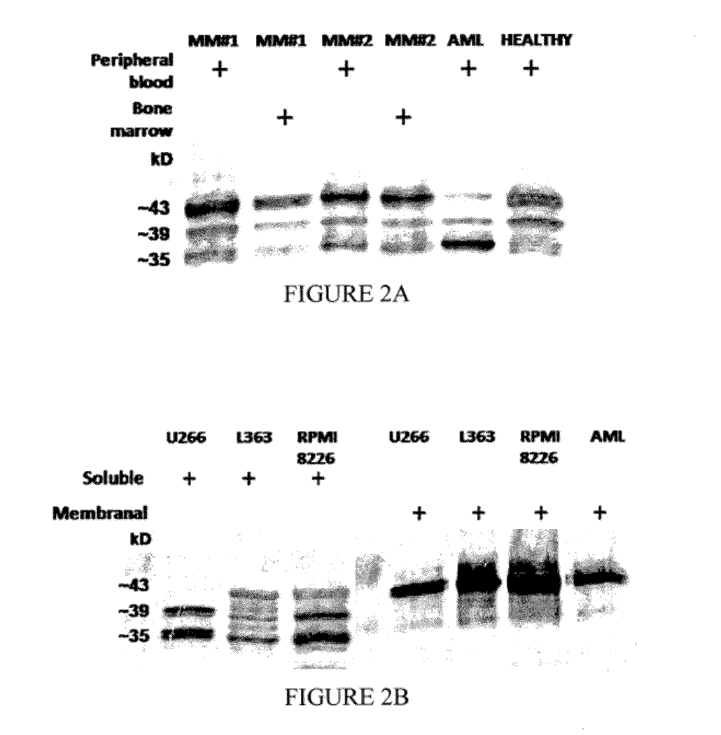

Isolation of sHLA molecules. To evaluate the sHLA-I molecules from sera of MM and AML patients and a healthy control, the immunoaffinity purified sHLA-I molecules were analyzed by SDS-PAGE followed by Western blotting (FIG. 2). For each of the sHLA-I samples, three bands of molecular weight ˜35, ˜39 and ˜43 kDa were observed (FIG. 2A), consistent with the three known forms of sHLA-I molecules [18-24].

The 35 kDa form corresponds to the extracellular region of the HLA molecule released by metalloproteases present at the cell membrane [19, 20]. The 39 kDa form corresponds to an alternative spliced form lacking the transmembrane domain [21]. The 43 kDa form corresponds to the intact molecule pinched off from the cells with fragments of the membrane [24]. The same three forms of sHLA molecules were also found to be secreted spontaneously from the three MM cell lines studied and were purified from the growth medium of the cells (FIG. 2B). However, only the 43 kDa form of intact HLA-I was observed in the membranal (mHLA) preparations from both the cancer cells and from MM cell lines (FIG. 2B).

Analysis of sHLA peptidomes. The analyses of the serum sHLA-I (ssHLA-1) peptidomes obtained from human peripheral blood (three MM patients, three AML patient, one ALL patient and four healthy controls) and from bone marrow of MM and ALL patients (three patients) resulted in identification of large repertoires of sHLA-I associated peptides. These peptidomes are composed of peptide families that fit the consensus binding sequences the HLA haplotype of these individuals. Since patient sera was found to contain about 1 μgr/ml of HLA-I molecules, about 10 ml of sera was sufficient for isolation and analysis of thousands of different sHLA-I associated peptides. Examples of peptides which were identified only in diseased subjects and not in healthy subjects are provided in Table 2.

TABLE 2

| | Accesion | | | | |
|---|---|---|---|---|---|
| | No. of | | | HLA-I | |
| | protein in | | | haplotype | Patient |
| Peptide | UniProt | Protein | Mass | (best fit) | Source |
| RPPPIGAEV | Q07820 | Induced myeloid | 935.531 | B5102 | MM-1 |
| (SEQ ID NO: | | leukemia cell | | | |
| 238) | | differentiation | | | |
| | | protein Mcl-1 | | | |
| GRIVTLISF | Q07820 | Induced myeloid | 1005.610 | B27 | AML-1 |
| (SEQ ID NO: | | leukemia cell | | | |
| 239) | | differentiation | | | |
| | | protein Mcl-1 | | | |
| VSGRILVV | Q14657 | L antigen family | 842.546 | B52 | MM-1 |
| (SEQ ID NO: | | member 3 | | | AML-1 |
| 240) | | (LAGE3) | | | |
| VVGKDLTV | Q14657 | L antigen family | 830.499 | B27, B35 | AML-1 |
| (SEQ ID NO: | | member 3 | | | |
| 241) | | (LAGE3) | | | |
| IHDIQEEEM | Q9NXZ1 | Sarcoma antigen 1 | 1159.494 | | MM-1 |
| (+15.995) | | (SAGE1) | | | |
| (SEQ ID NO: | | | | | |
| 242) | | | | | |
| RVFPWFSVK | Q03164 | Histone-lysine N- | 1165.652 | B27 | AML-1 |
| (SEQ ID NO: | | methyltransferase | | | |
| 243) | | HRX | | | |
| AMPGVNNL | P31314 | T-cell leukemia | 815.409 | B27 | MM-1 |
| (SEQ ID NO: | | homeobox protein | | | |
| 244) | | 1 | | | |
| VSLKGCTL | Q13009 | T-lymphoma | 820.460 | B51 | MM-2 |
| (SEQ ID NO: | | invasion and | | | |
| 245) | | metastasis- | | | |
| | | inducing protein 1 | | | |
| VVFPFPVNK | P04198 | N-myc proto- | 1046.604 | B27 | AML-1 |
| (SEQ ID NO: | | oncogene protein | | | |
| 246) | | | | | |
| GRAPGGLSL | P17275 | Transcription | 827.474 | B27 | AML-1 |
| (SEQ ID NO: | | factor jun-B | | | |
| 247) | | | | | |
| DVAVKVLKV | P10398 | A-Raf proto- | 970.630 | B51 | MM-1 |
| (SEQ ID NO: | | oncogene | | | |
| 248) | | serine/threonine- | | | |
| | | protein kinase | | | |
| KVYENYPTY | P35659 | Protein DEK | 1176.558 | B27 | AML-1 |
| (SEQ ID NO: | | | | | |
| 249) | | | | | |
| TAVAPNVAL | P12755 | Ski oncogene | 855.494 | B51 | AML-1 |
| (SEQ ID NO: | | | | | |
| 250) | | | | | |
| TSALPIIQK | Q99541 | Adipophilin | 970.954 | B27 | MM-1 |
| (SEQ ID NO: | | (ADFP) | | | MM-2 |
| 251) | | | | | |
| SLLTSSKGQLQ | Q99541 | Adipophilin | 1289.473 | A3 | AML-1 |
| K | | (ADFP) | | | |
| (SEQ ID NO: | | | | | |
| 252) | | | | | |
| GGFSQGPGNP | O00512 | B-cell | 1088.476 | B51 | MM-1 |
| GN | | CLL/lymphoma 9 | | | |
| (SEQ ID NO: | | protein | | | |
| 253) | | | | | |
| FPNVEIVTI | Q6W2J9 | BCL-6 corepressor | 1031.578 | B51 | AML-1 |
| (SEQ ID NO: | | | | | |
| 254) | | | | | |
| TLYEAVREV | P62906 | 60S ribosomal | 1079.574 | A02 | MM-2 |
| (SEQ ID NO: | | protein L10a | | | |
| 255) | | | | | |
| PSPRTATPI | O75871 | Carcinoembryonic | 939.526 | Cw04 | AML-1 |
| (SEQ ID NO: | | antigen-related cell | | | |
| 256) | | adhesion molecule | | | |
| | | 4 | | | |
| SHDDIVTEF | P30260 | Cell division cycle | 1062.474 | | MM-1 |
| (SEQ ID NO: | | protein 27 | | | |
| 257) | | homolog | | | |
| LPVDLAEEL | P42771 | Cyclin-dependent | 998.541 | B35, B52 | MM-2 |
| (SEQ ID NO: | | kinase inhibitor | | | |
| 258) | | 2A, isoforms 1/2/3 | | | |
| IGVDFALKV | P57729 | Ras-related protein | 961.572 | B51 | MM-1 |
| (SEQ ID NO: | | Rab-38 | | | |
| 259) | | | | | |
| TALLAGLVSLL | P14679 | Tyrosinase | 1070.683 | B51 | MM-1 |
| (SEQ ID NO: | | | | | |
| 260) | | | | | |
| EVFPLAMNY | P30279 | G1/S-specific | 1083.519 | A01 | MM-1 |
| (SEQ ID NO: | | cyclin-D2 | | | |
| 261) | | | | | |
| FAFGEPREL | O60732 | Melanoma- | 1065.537 | B51 | MM-1 |
| (SEQ ID NO: | | associated antigen | | | |
| 262) | | C1 | | | |
| SSVPRTAEL | Q99836 | Myeloid | 959.516 | | MM-1 |
| (SEQ ID NO: | | differentiation | | | |
| 263) | | primary response | | | |
| | | protein MyD88 | | | |
| GRWPWQGSL | Q9Y6M0 | Testisin | 1086.549 | B27 | AML-1 |
| (SEQ ID NO: | | | | | |
| 264) | | | | | |
| GTPAGGGFPR | Q07352 | Butyrate response | 916.464 | | MM-1, |
| (SEQ ID NO: | | factor 1 | | | MM-2 |
| 265) | | | | | |
| VTKPVGGNY | Q99613 | Eukaryotic | 934.500 | | MM-2, |
| (SEQ ID NO: | | translation | | | AML-3 |
| 266) | | initiation factor 3 | | | |
| | | subunit C | | | |
| LLDIQSSGRAK | Q99613 | Eukaryotic | 1187.675 | | AML-1 |
| (SEQ ID NO: | | translation | | | |
| 267) | | initiation factor 3 | | | |
| | | subunit C | | | |
| SVSVVITK | P42566 | Epidermal growth | 946.557 | A03 | MM-1, |
| (SEQ ID NO: | | factor receptor | | | MM-2, |
| 268) | | substrate 15 | | | AML-1, |
| | | | | | AML-3, |
| | | | | | ALL-1 |
| SGFEGMFTK | P49792 | E3 SUMO-protein | 1003.456 | | MM-2. |
| (SEQ ID NO: | | ligase RanBP2 | | | ALL-1 |
| 269) | | | | | |
| STEPPYSQK | P68104 | Elongation factor | 1036.495 | | MM-1, |
| (SEQ ID NO: | | 1-alpha 1 | | | MM-2, |
| 270) | | | | | ALL-1 |
| TTTGHLIYK | P68104 | Elongation factor | 1033.568 | | ALL-1 |
| (SEQ ID NO: | | 1-alpha 1 | | | |
| 271) | | | | | |
| STTTGHLIYK | P68104 | Elongation factor | 1120.600 | | ALL-1 |
| (SEQ ID NO: | | 1-aplha 1 | | | |
| 272) | | | | | |
| VFDPVPVGV | Q08211 | ATP-dependent | 928.514 | Cw04 | AML-1 |
| (SEQ ID NO: | | RNA helicase A | | | |
| 273) | | | | | |
| GQLSVHTPK | Q9H334 | Forkhead box | 966.537 | B27 | AML-1 |
| (SEQ ID NO: | | protein P1 | | | |
| 274) | | | | | |
| DGYVVKETI | Q15418 | Ribosomal protein | 1023.536 | | ALL-1 |
| (SEQ ID NO: | | S6 kinase alpha-1 | | | |
| 275) | | | | | |
| SVYSPSGPVNR | Q9NS56 | E3 ubiquitin- | 1162.586 | | AML-1 |
| (SEQ ID NO: | | protein ligase | | | |
| 276) | | Topors | | | |

The identified sHLA peptides from the plasma samples (above 12000 in this study) were filtered according to the degree of confidence in their identification scores by the different software tools (Pep-Miner, Sequest and Mascot) and by the accuracy of the peptides mass measurements. A subset of high score peptides (about 2000) was identified.

Most of the identified peptides appear to be authentic HLA ligands, since their amino acid sequences fit the consensus binding motifs of the HLA-A, -B and -C alleles of the respective subjects from which the samples were obtained. For example, the HLA-I type of the healthy subject designated Healthy-1 was determined as A01, A02, B35 and Cw04, and the consensus binding motifs of each these alleles are known. Therefore, all the high certainty plasma sHLA peptides identified in this sample could be divided according to their fitness to the binding motif of the subject's alleles. As summarized in Table 3, out of 250 high certainty sHLA peptides identified for Healthy-1, 98% fit the consensus binding motifs of each of the HLA-I alleles.

TABLE 3
Fitness of sHLA peptides to their haplotype consensus binding motifs.

| | % high | HLA | | |
|---|---|---|---|---|
| | certainty | supertype | HLA supertype | HLA supertype |
| | HLA | (HLA-A, | consensus binding | consensus binding |
| HLA allele | peptides | HLA-B) | motif of B pocket | motif of F pocket |
| HLA-A01 | 37 | A01 | ATSVLIMQ | FWYLIM |
| HLA-A02 | 12 | A02 | ATSVLIMQ | LIVMQA |
| HLA-B35 | 49 | B07 | P | FWYLIVMQA |
| HLA-Cw04 | | | HLA-Cw04:YPF | HLA-Cw04:LFM |
| No correlation with | 2 | | | |
| known HLA allele | | | | |
| binding motif | | | | |

Any possible contamination of the peptide preparations contributed by peptides derived from blood clotting and plasma proteins were readily filtered out at the analysis stage upon ascertaining that such peptides did not fit the sizes or the binding consensus motifs of the HLA haplotypes of the subjects. However, to reduce such contamination at the peptide isolation stage, protease inhibitors were added to the plasma immediately after separation from cellular components, and their levels were further reduced by an extra wash with non-ionic detergents added to the immunoaffinity purification procedure.

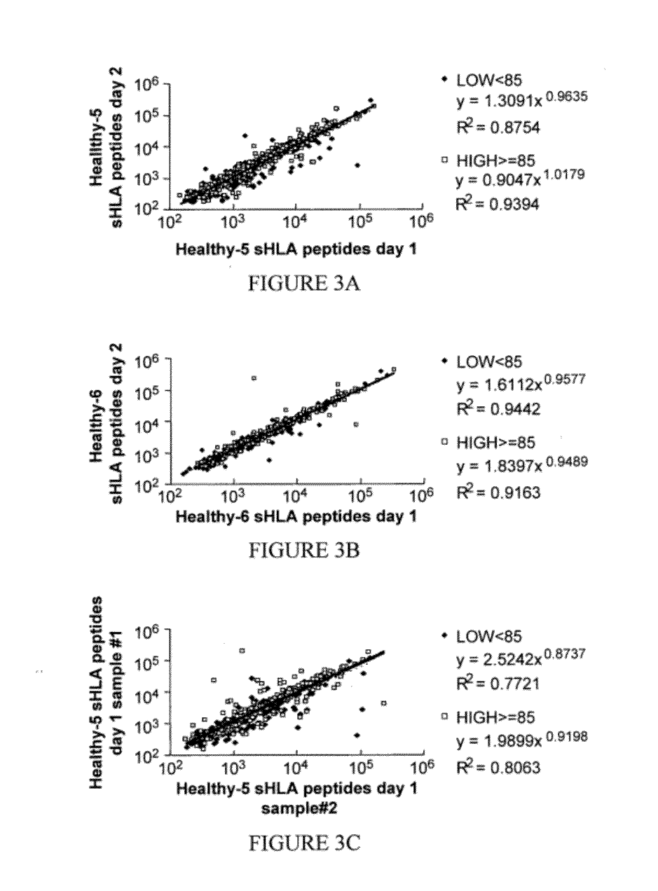

Similar sHLA peptidomes are detected in the plasma of the same subject collected on different days. One validation of the method described herein was provided by the observation that consistent peptide repertoires were observed in different plasma samples collected from the same subject on different days. The very strong similarities observed between such samples are manifested in two aspects. The first is the number of identical peptides detected in the two samples, which were indeed relatively high, as shown in Table 4. The second is the LC-MS signal intensity of each of the peptides detected in the different plasma samples. As can be seen in FIGS. 3A and 3B, the same peptides detected from plasma samples collected on separate days from the same subject were observed with similar lists of peptides and LC-MS signal intensities. Each point in FIGS. 3-7 indicates the normalized signal intensities of the same peptide detected in the different sHLA peptidomes. Both high score (square symbols) and low score peptides (diamond symbols) were spread across the entire four orders of dynamic range of signal intensities. Importantly, the similarity between the sHLA peptidomes from different samples collected on two different days from a single subject (FIGS. 3A and 3B) were as high that observed from a single sample divided into two and analyzed by two separate LC-MS/MM analyses (FIG. 3C).

TABLE 4
Number of identical peptides identified in different samples from a single subject.

| | MM-1 | MM-2 | AML-1 | AML-2 | AML-3 | ALL-1 | H-1 | H-2 | H-3 | H-4 |
|---|---|---|---|---|---|---|---|---|---|---|
| MM-1 | 1305 | 82; 98 | 73; 54 | 21; 41 | 7; 13 | 18; 30 | 48; 48 | 19; 39 | 80; 120 | 17; 23 |
| MM-2 | | 1385 | 84; 77 | 27; 26 | 13; 22 | 36; 63 | 59; 58 | 57; 40 | 40; 43 | 25; 32 |
| AML-1 | | | 2080 | 18; 19 | 17; 25 | 27; 36 | 215; 266 | 21; 19 | 20; 24 | 24; 26 |
| AML-2 | | | | 467 | 29; 29 | 23; 14 | 14; 24 | 24; 38 | 34; 72 | 47; 101 |
| AML-3 | | | | | 342 | 20; 19 | 14; 15 | 9; 19 | 13; 26 | 8; 18 |
| ALL-1 | | | | | | 457 | 17; 19 | 13; 13 | 16; 12 | 11; 17 |
| H-1 | | | | | | | 1965 | 73; 105 | 16; 29 | 26; 33 |
| H-2 | | | | | | | | 639 | 44; 71 | 30; 47 |
| H-3 | | | | | | | | | 644 | 22; 41 |
| H-4 | | | | | | | | | | 1877 |

Shared MS/MS clusters of peptides isolated from plasma samples of different subjects with Pep-Miner scores 70 to 85 (left number) and Pep-Miner score higher than 85 (right number). For each subject the analysis with the largest number of identified peptides was selected for this table.
H-1, Healthy-1;
H-2, Healthy-2;
H-3, Healthy-3;
H-4, Healthy-4.

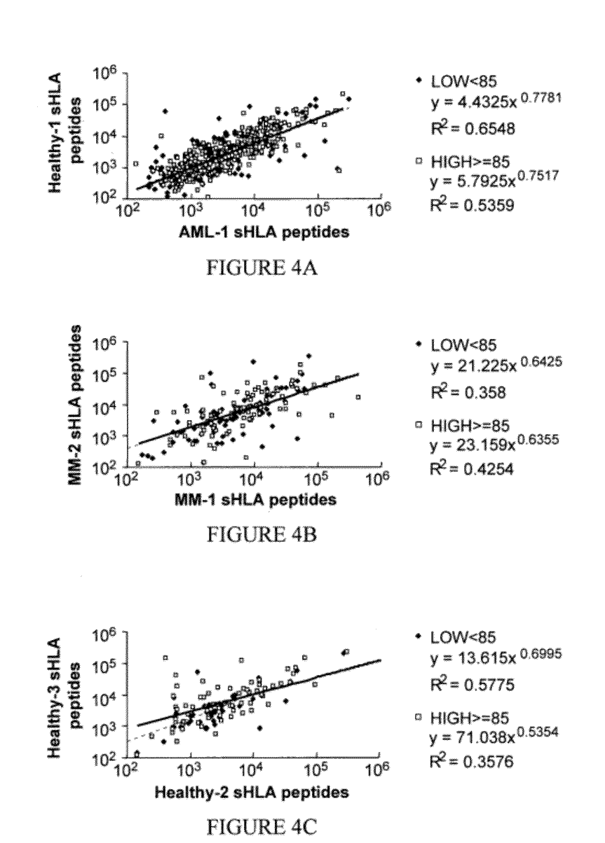

HLA haplotype influences the sHLA peptidome. Different individuals have different HLA haplotypes and therefore their HLA peptidomes differ according to the peptide binding properties of their unique HLA alleles (see for example, Sidney et al BMC Immunol. 2008; 9:1). Indeed, when sHLA peptidomes of different subjects were compared, these peptidomes differed significantly, in accordance with the differences in their HLA haplotypes. These differences were manifested in both the lists of identified sHLA peptides and also in the signal intensities of the identical peptides. Large numbers of identical peptides were observed among peptidomes of subjects who share similar HLA haplotypes. For example, as many as 481 identical peptides were observed between the peptidomes of subject AML-1 (out of total of 2080 peptides) and subject Healthy-1 (out of total of 1965 peptides) who share the HLA alleles HLA-B35 and HLA Cw4 (FIG. 4A). In contrast, significantly fewer identical peptides were observed between pairs of HLA-1-mismatched subjects, as shown in FIGS. 4B (MM-1 and MM-2) and 4C (Healthy-2 and Healthy-3).

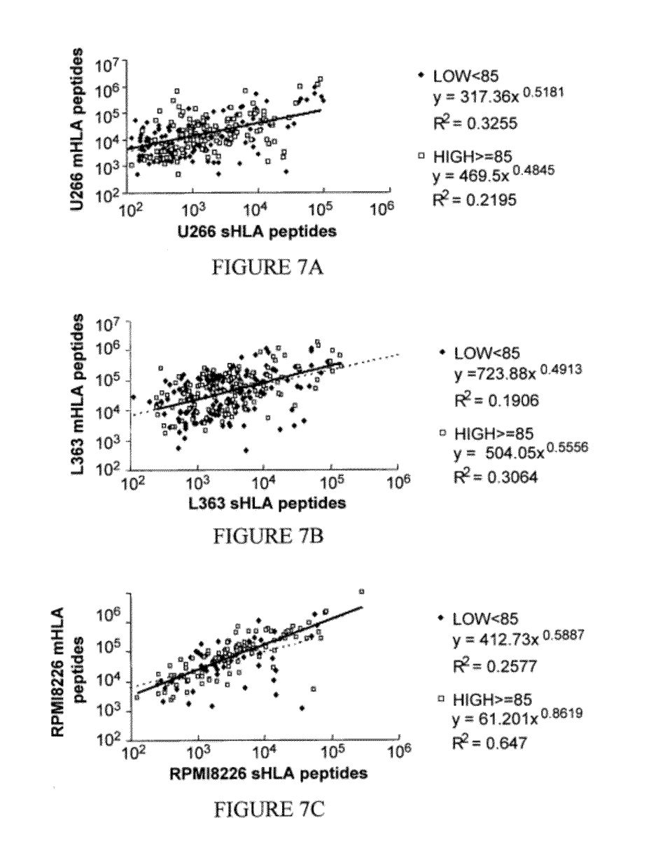

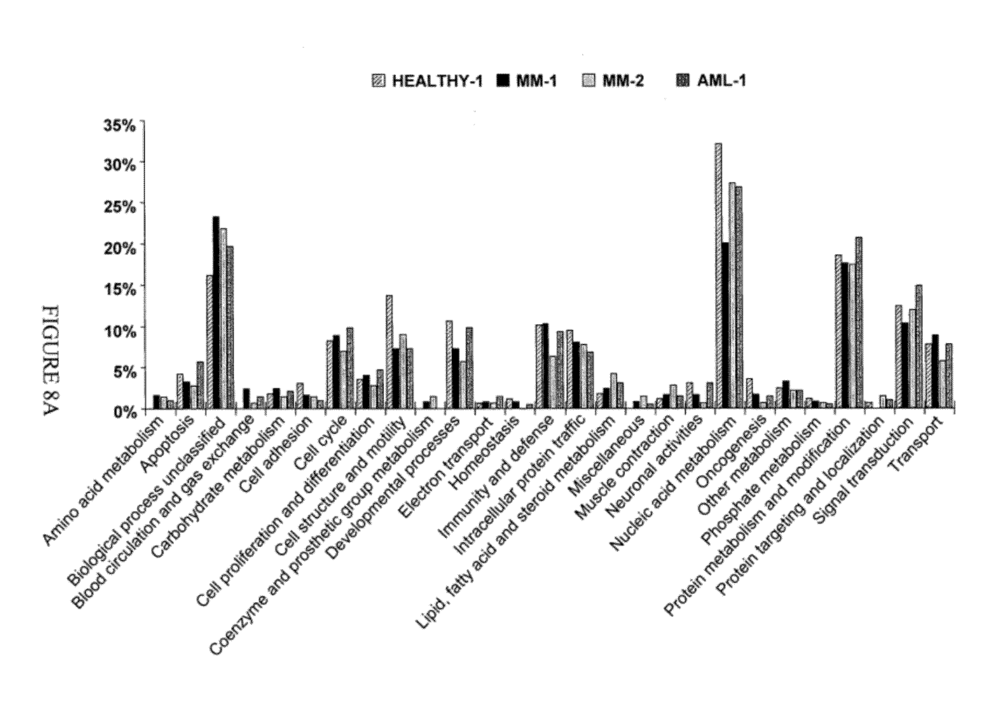

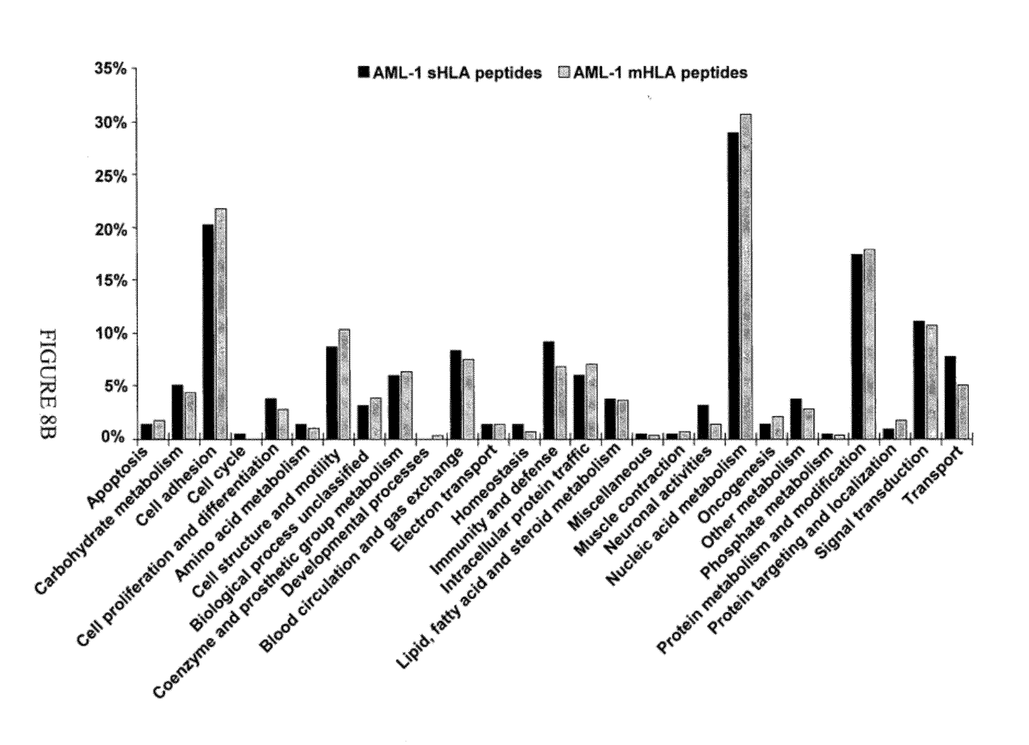

The soluble HLA and membranal HLA peptidomes of cancer cells are similar. The sHLA and the mHLA peptidomes were compared after purifying the mHLA molecules by detergent solubilization of cancer cells, both those from patients and that of cancer cell lines. Comparison of the membranal HLA peptidomes and the sHLA peptidomes from three multiple myeloma cultured cell lines (L363, RPMI8226 and U266) indicated greater than 45% similarity in the number of identical peptides (out of the 1440 high certainty peptides from a total of 14,000 identified peptides), and the MS peak area of the shared peptides between sHLA and mHLA were reasonable as well (FIG. 7).

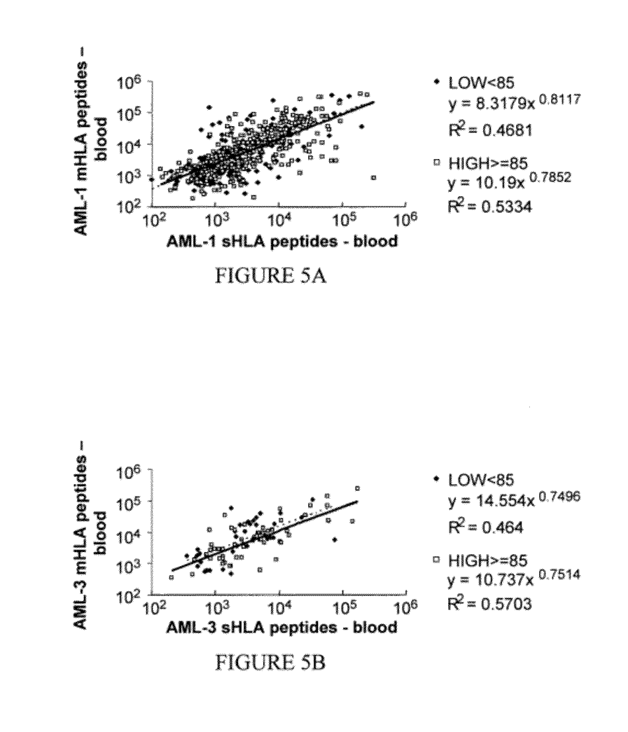

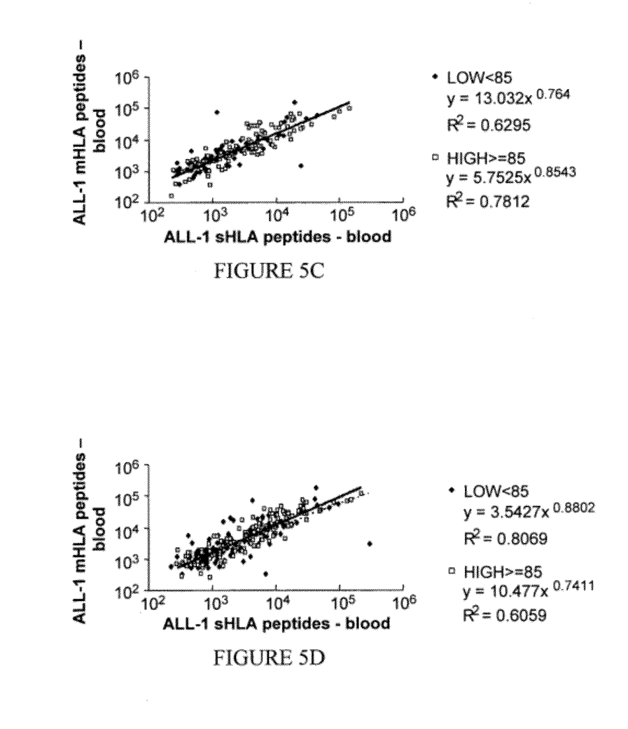

Next, the plasma sHLA peptidomes of leukemia patients were compared to the mHLA peptidomes isolated from their cancer cells, both collected from the same blood samples. Indeed, in advanced diseases, such as AML and ALL, a significant similarity of above 50% was observed between the mHLA peptidomes and the plasma sHLA peptidomes of the same patients (FIGS. 5A and 5C). In addition, a degree of similarly was observed between the mHLA and sHLA peptidomes from bone marrow, both in subject AML-3 (FIG. 5B) and subject ALL-1 (FIG. 5D). These results validate the paradigm that the plasma sHLA peptidome represents the mHLA peptidome of the cancer cells.

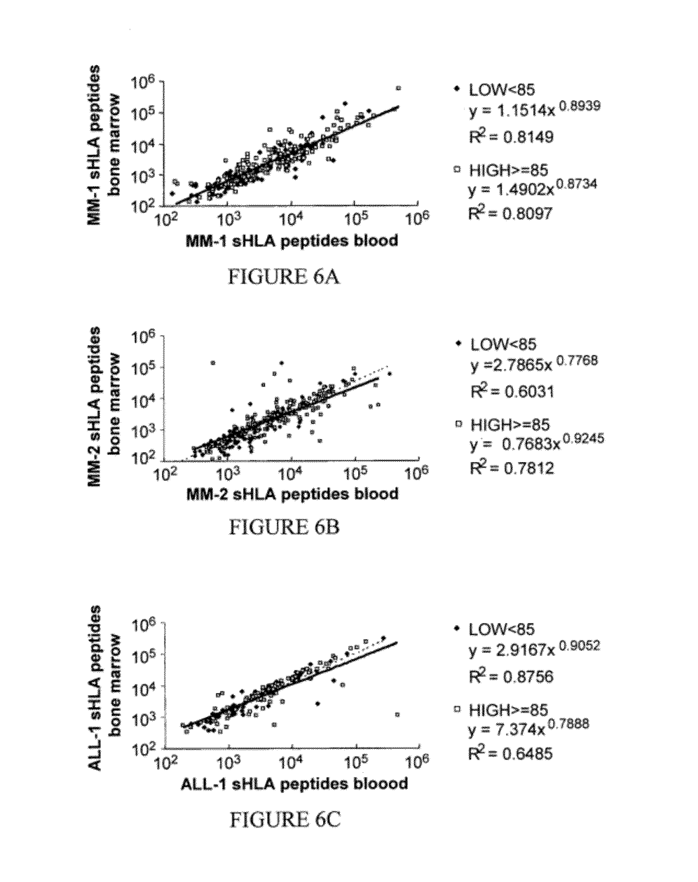

Similar sHLA peptidomes were observed in peripheral blood plasma and bone marrow collected from the same patient. The sHLA peptidomes of the bone marrow and of the peripheral blood samples of MM and ALL patients were compared, resulting in identity of about 70% (FIGS. 6A-C). These results indicate that sHLA molecules provide information about the tumor microenvironment, since they circulate freely to the periphery from where they can be easily collected.

Cancer related sHLA peptides in the plasma. The HLA peptidome represents degradation products of a significant part of the cellular proteome. Indeed, both the sHLA and mHLA peptidomes were derived from cellular proteins of different families and cellular functions. No significant preference was observed in the repertoires of the source proteins of the HLA peptidomes to membranal, cytoplasmic or nuclear proteins. The gene ontology analyses of the identified sHLA and mHLA peptidomes are displayed in FIGS. 8A and 8B respectively, showing that both types of peptidomes include peptides derived from similar sources.

Numerous known cancer-related peptide antigens were identified in the sHLA peptidomes recovered from the cancer patients, but not from those of the healthy controls. Examples of such cancer associated peptides are listed in Table 2. The identified cancer antigens of potential interest belong to the main families of tumor antigens, including for example tumor testis antigen, embryonic antigen and products of known tumor genes.

Discussion. Immunoaffinity purification of the sHLA molecules with their bound peptides provides at least five orders of magnitude enrichment of the serum biomarkers. It bypasses the inherent difficulty associated with detection of cancer proteins or peptides present at diminishingly small concentrations in the otherwise protein rich plasma. The sHLA molecules carry defined sets of peptides, largely derived from the cancer cells. This is in contrast to the non-specific binding of peptides to the serum albumin previously suggested for analysis of its adsorbed peptides as cancer biomarkers (1).

Since the sHLA peptidomes are derived from both the healthy and the diseased cells in the body, it is expected that in cases of high tumor loads, larger fractions of the plasma sHLA peptidomes will originate from the mHLA of the tumor cells. Furthermore, cancer cells release large amounts of sHLA to the circulation, possibly as an attempt to evade the anti-cancer immune response of T cells. Therefore, the degree of contribution of the diseased cells to the sHLA peptidomes is expected to vary according to the tumor type, size and its propensity to release sHLA to the circulation. Indeed, in advanced diseases, such as AML and ALL, where large numbers of cancer cells are present in the blood, a similarity of above 50% was observed between the mHLA and the plasma sHLA peptidomes of the same patients.

### REFERENCES

1. Liotta, L. A. and E. F. Petricoin, Serum peptidome for cancer detection: spinning biologic trash into diagnostic gold. J Clin Invest, 2006. 116(1): p. 26-30.
2. Lopez, M. F., et al., High-resolution serum proteomic profiling of Alzheimer disease samples reveals disease-specific, carrier-protein-bound mass signatures. Clin Chem, 2005. 51(10): p. 1946-54.
3. Lowenthal, M. S., et al., Analysis of albumin-associated peptides and proteins from ovarian cancer patients. Clin Chem, 2005. 51(10): p. 1933-45.
4. Barnea, E., et al., Analysis of endogenous peptides bound by soluble MHC class I molecules: a novel approach for identifying tumor-specific antigens. Eur J Immunol, 2002. 32(1): p. 213-22.
5. Milner, E., et al., The turnover kinetics of major histocompatibility complex peptides of human cancer cells. Mol Cell Proteomics, 2006. 5(2): p. 357-65.
6. Albitar, M., et al., Levels of soluble HLA-I and beta2M in patients with acute myeloid leukemia and advanced myelodysplastic syndrome: association with clinical behavior and outcome of induction therapy. Leukemia, 2007. 21(3): p. 480-8.
7. Albitar, M., et al., Clinical relevance of soluble HLA-I and beta2-microglobulin levels in non-Hodgkin's lymphoma and Hodgkin's disease. Leuk Res, 2007. 31(2): p. 139-45.
8. Leleu, X., et al., Total soluble HLA class I and soluble HLA-G in multiple myeloma and monoclonal gammopathy of undetermined significance. Clin Cancer Res, 2005. 11(20): p. 7297-303.
9. Migliaresi, S., et al., Increased serum concentrations of soluble HLA-class I antigens in hepatitis C virus related mixed cryoglobulinaemia. Ann Rheum Dis, 2000. 59(1): p. 20-5.
10. Nocito, M., et al., Increased soluble serum HLA class I antigens in patients with lymphoma. Hum Immunol, 1997. 58(2): p. 106-11.
11. Perosa, F., et al., Size variants of beta-2-microglobulin-free human leucocyte antigen class I heavy chain make different contributions to its serum increase in multiple myeloma. Br J Haematol, 2003. 120(1): p. 36-43.
12. Schutt, P., et al., The clinical significance of soluble human leukocyte antigen class-I, ICTP, and RANKL molecules in multiple myeloma patients. Hum Immunol, 2008. 69(2): p. 79-87.
13. Shimura, T., et al., Quantification of serum-soluble HLA class I antigens in patients with gastric cancer. Hum Immunol, 1994. 40(3): p. 183-6.
14. Shimura, T., et al., Clinical significance of soluble form of HLA class 1 molecule in Japanese patients with pancreatic cancer. Hum Immunol, 2001. 62(6): p. 615-9.
15. Tsuchiya, N., et al., Elevated serum level of soluble HLA class I antigens in patients with systemic lupus erythematosus. Arthritis Rheum, 1996. 39(5): p. 792-6.
16. Westhoff, U., et al., Soluble HLA class I concentrations and GVHD after allogeneic marrow transplantation. Transplantation, 1989. 48(5): p. 891-3.
17. Westhoff, U., C. Fox, and F. J. Otto, Soluble HLA class I antigens in plasma of patients with malignant melanoma. Anticancer Res, 1998. 18(5B): p. 3789-92.
18. Aultman, D., et al., Soluble HLA in human body fluids. Hum Immunol, 1999. 60(3): p. 239-44.
19. Demaria, S, and Y. Bushkin, Soluble HLA proteins with bound peptides are released from the cell surface by the membrane metalloproteinase. Hum Immunol, 2000. 61(12): p. 1332-8.
20. Demaria, S., et al., Soluble beta 2-microglobulin-free class I heavy chains are released from the surface of activated and leukemia cells by a metalloprotease. J Biol Chem, 1994. 269(9): p. 6689-94.
21. Krangel, M. S., Secretion of HLA-A and -B antigens via an alternative RNA splicing pathway. J Exp Med, 1986. 163(5): p. 1173-90.
22. Puppo, F., et al., Soluble HLA antigens: new roles and uses. Immunol Today, 1997. 18(4): p. 154-5.
23. Puppo, F., et al., Serum HLA class I antigens: markers and modulators of an immune response? Immunol Today, 1995. 16(3): p. 124-7.
24. Tabayoyong, W. B. and N. Zavazava, Soluble HLA revisited. Leuk Res, 2007. 31(2): p. 121-5.
25. Campoli, M. and S. Ferrone, Tumor escape mechanisms: potential role of soluble HLA antigens and NK cells activating ligands. Tissue Antigens, 2008. 72(4): p. 321-34.
26. Carbone, E., et al., HLA class I, NKG2D, and natural cytotoxicity receptors regulate multiple myeloma cell recognition by natural killer cells. Blood, 2005. 105(1): p. 251-8.
27. Contini, P., et al., Apoptosis of antigen-specific T lymphocytes upon the engagement of CD8 by soluble HLA class I molecules is Fas ligand/Fas mediated: evidence for the involvement of p56lck, calcium calmodulin kinase II, and Calcium-independent protein kinase C signaling pathways and for NF-kappaB and NF-AT nuclear translocation. J Immunol, 2005. 175(11): p. 7244-54.
28. Contini, P., et al., In vivo apoptosis of CD8(+) lymphocytes in acute myeloid leukemia patients: involvement of soluble HLA-I and Fas ligand. Leukemia, 2007. 21(2): p. 253-60.
29. Jinushi, M., et al., Impairment of natural killer cell and dendritic cell functions by the soluble form of MHC class I-related chain A in advanced human hepatocellular carcinomas. J Hepatol, 2005. 43(6): p. 1013-20.
30. Puppo, F., et al., Soluble human MHC class I molecules induce soluble Fas ligand secretion and trigger apoptosis in activated CD8(+) Fas (CD95)(+) T lymphocytes. Int Immunol, 2000. 12(2): p. 195-203.
31. Spaggiari, G. M., et al., Soluble HLA class I molecules induce natural killer cell apoptosis through the engagement of CD8: evidence for a negative regulation exerted by members of the inhibitory receptor superfamily. Blood, 2002. 99(5): p. 1706-14.
32. Spaggiari, G. M., et al., Soluble HLA class I induces NK cell apoptosis upon the engagement of killer-activating HLA class I receptors through FasL-Fas interaction. Blood, 2002. 100(12): p. 4098-107.
33. Zavazava, N. and M. Kronke, Soluble HLA class I molecules induce apoptosis in alloreactive cytotoxic T lymphocytes. Nat Med, 1996. 2(9): p. 1005-10.
34. Bangia, N. and S. Ferrone, Antigen presentation machinery (APM) modulation and soluble HLA molecules in the tumor microenvironment: do they provide tumor cells with escape mechanisms from recognition by cytotoxic T lymphocytes? Immunol Invest, 2006. 35(3-4): p. 485-503.
35. Ishihama, Y., et al., Microcolumns with self-assembled particle frits for proteomics. J Chromatogr A, 2002. 979(1-2): p. 233-9.
36. Sette, A. and J. Sidney, Nine major HLA class I supertypes account for the vast preponderance of HLA-A and -B polymorphism. Immunogenetics, 1999. 50(3-4): p. 201-12.
37. Beer, I. Barnea, E., Ziv, T., and Admon, A. (2004) Improving large-scale proteomics by clustering of mass spectrometry data. Proteomics 4, 950-960.
38. Eng, J., McCormack, A., and Yates, J. (1994) An approach to correlate tandem mass spectral data of peptides with amino acid sequences in a protein database. J. Amer. Soc. Mass. Spect. 5, 976-989.
39. Perkins, D. N., Pappin, D. J., Creasy, D. M., and Cottrell, J. S. (1999) Probability-based protein identification by searching sequence databases using mass spectrometry data. Electrophoresis 20, 3551-3567.
40. Parker, K. C., Bednarek, M. A., and Coligan, J. E. (1994) Scheme for ranking potential HLA-A2 binding peptides based on independent binding of individual peptide side-chains. J Immunol 152, 163-175.
41. Andreas Schlosser, R. V.-E. (2003) Volatile polydimethylcyclosiloxanes in the ambient laboratory air identified as source of extreme background signals in nanoelectrospray mass spectrometry. Journal of Mass Spectrometry 38, 523-525

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1-66. (canceled)

67. A method for diagnosing, staging, prognosing or determining the risk of developing a malignant disease in a subject, the method comprising the steps of:
(i) selecting a suitable biological fluid sample from a subject;
(ii) processing the biological fluid sample so as to obtain an enriched pool of endogenous sHLA-I molecules with peptide ligands bound thereto from said sample; and
(iii) detecting sHLA-I associated peptides that represent a subset of disease-associated peptides in the pool of peptide ligands bound to sHLA-I molecules obtained in step (ii); wherein the amounts of the disease-associated peptides relative to the amount of said disease-associated peptides determined in a reference sample, is indicative of the malignant disease or a risk of developing the malignant disease in the subject.

68. The method according to claim 67, wherein the biological sample is selected from the group consisting of blood, plasma, serum, a bone marrow aspirate, a plasmapheresis sample, a leukopheresis sample, saliva, urine, cerebral spinal fluid, semen, tears and mucus.

69. The method according to claim 67, wherein step (ii) comprises contacting the biological fluid sample with a solid substrate, wherein the solid substrate comprises an immobilized antibody having specificity for sHLA-I, so as to bind sHLA-I molecules present in the sample; and thereafter dissociating bound sHLA-I molecules with peptide ligands bound thereto from the solid substrate, so as to obtain an enriched pool of sHLA-I molecules with peptide ligands bound thereto.

70. The method of claim 67, further comprising prior to step (iii) dissociating the peptide ligands bound to the sHLA-I molecules obtained in (ii), so as to obtain a pool of peptides.

71. The method according to claim 69, wherein the immobilized antibody of step (ii) has specificity for at least one sHLA-I protein selected from the group consisting of sHLA-A, sHLA-B, sHLA-C, sHLA-E, sHLA-G, sHLA-H and combinations thereof.

72. The method according to claim 67, wherein the malignant disease selected from the group consisting of a hematologic cancer, bladder cancer, bone cancer, breast cancer, cervical cancer, colon cancer, endometrial cancer, gastric cancer, head and neck cancer, hepatic cancer, kidney cancer, lung cancer, melanoma, ovarian cancer, pancreatic cancer, prostate cancer, renal cancer, sarcoma, skin cancer, stomach cancer, testicular cancer and thyroid cancer.

73. The method according to claim 72, wherein the hematologic cancer is selected from the group consisting of multiple myeloma, acute lymphoblastic leukemia, acute myeloid leukemia, chronic lymphocytic leukemia, chronic myelogenous leukemia, Hodgkin's disease, non-Hodgkin's lymphoma and hairy cell leukemia.

74. The method according to claim 72, wherein the malignant disease is a hematologic cancer and the disease-associated peptides have amino acid sequences selected from the group consisting of SEQ ID NOS: 1-276.

75. The method according to claim 73, wherein the hematologic cancer is acute myeloid leukemia and the disease-associated peptides have amino acid sequences selected from the group consisting of SEQ ID NOS: 1-78.

76. The method according to claim 73, wherein the hematologic cancer is multiple myeloma and the disease-associated peptides have amino acid sequences selected from the group consisting of SEQ ID NOS: 79-166.

77. The method according to claim 73, wherein the hematologic cancer is acute lymphoblastic leukemia and the disease-associated peptide has an amino acid sequence selected from the group consisting of SEQ ID NOS: 167-216 and combinations thereof.

78. The method according to claim 73, wherein the hematologic cancer is selected from multiple myeloma, acute myeloid leukemia and acute lymphoblastic leukemia and the disease-associated peptide has an amino acid sequence selected from the group consisting of SEQ ID NOS: 217-237 and combinations thereof.

79. The method according to claim 74, wherein the at least one disease-associated peptide has an amino acid sequence selected from the group consisting of SEQ ID NOS: 238-276 and combinations thereof.

80. The method according to claim 67, wherein the method is carried out for a subject who does not exhibit clinical signs of disease.

81. The method according to claim 84, wherein the solid substrate comprises at least one of immunoaffinity beads, a microaffinity column, and a microwell plate.

82. The method according to claim 67, wherein the detecting in step (iii) comprises at least one of mass spectrometry, an immunoassay or an array-based binding assay system.

83. The method according to claim 67, wherein the presence of a particular subset of peptides in amounts that are within the range determined from other patients having a known stage or outcome of the same disease, can be used as an indicator of stage of prognosis of the disease in the subject.

84. A method of diagnosing or determining the risk of developing a disease in a subject, the method comprising the steps of:
(i) selecting a suitable biological fluid sample from a subject;
(ii) processing the biological fluid sample so as to obtain an enriched pool of endogenous sHLA-I molecules with peptide ligands bound thereto from said sample; and
(iii) detecting at least one disease-associated peptide in the pool of sHLA-I molecules with peptide ligands bound thereto obtained in step (ii); wherein the amount of the at least one disease-associated peptide relative to the amount of said disease-associated peptide determined in a reference sample from at least one non-diseased subject, is indicative of a disease or the risk of developing the disease in the subject. The method according to claim 84, wherein the disease is selected from the group consisting of a malignant disease, an autoimmune disease and an infectious disease.

85. The method according to claim 84, wherein the biological sample is selected from the group consisting of blood, plasma, serum, a bone marrow aspirate, a plasmapheresis sample, a leukopheresis sample, saliva, urine, cerebral spinal fluid, semen, tears and mucus.

86. The method according to claim 84, wherein step (ii) comprises contacting the biological fluid sample with a solid substrate, wherein the solid substrate comprises an immobilized antibody having specificity for sHLA-I, so as to bind sHLA-I molecules present in the sample; and thereafter dissociating bound sHLA-I molecules from the solid substrate, so as to obtain an enriched pool of sHLA-I molecules with peptide ligands bound thereto.

87. The method of claim 67, further comprising prior to step (iii) dissociating the peptide ligands bound to the sHLA-I molecules obtained in (ii), so as to obtain a pool of peptides.

88. The method according to claim 84, wherein the immobilized antibody of step (ii) has specificity for has specificity for at least one sHLA-I protein selected from the group consisting of sHLA-A, sHLA-B, sHLA-C, sHLA-E, sHLA-G and sHLA-H and combinations thereof.

89. A diagnostic kit, the kit comprising a first solid substrate comprising an immobilized antibody having specificity for sHLA-I, and a second solid substrate comprising at least one immobilized binding reagent having specificity for at least one disease-associated peptide amino acid sequence.

90. The kit according to claim 89, wherein the second solid substrate comprises a plurality of binding reagents, and wherein each binding reagent has specificity for a different disease-associated peptide.

91. The kit according to claim 90, wherein the antibody immobilized on the first solid substrate has specificity for a soluble HLA-I protein selected from the group consisting of sHLA-A, sHLA-B, sHLA-C, sHLA-E, sHLA-G and sHLA-H and combinations thereof.

92. The kit according to claim 90, wherein the at least one immobilized binding reagent is selected from the group consisting of an antibody, an antibody fragment and a TCR-like molecule.

93. The kit according to claim 92, wherein the TCR-like molecule comprises a TCR-like antibody.

94. The kit according to claim 90, wherein the second solid substrate comprises an immunoassay or an array-based binding assay system.

95. The kit according to claim 90, wherein the at least one disease-associated peptide amino acid sequence is selected from the group consisting of SEQ ID NOS: 1-276 and combinations thereof.


SEQUENCE LISTING (276 sequences)

SEQ ID NO: 1 - protein, 10 aa, Artificial Sequence
  Synthetic
ALKNPPINTK

SEQ ID NO: 2 - protein, 9 aa, Artificial Sequence
  Synthetic
GRAPGGLSL

SEQ ID NO: 3 - protein, 9 aa, Artificial Sequence
  Synthetic
RALGAAALL

SEQ ID NO: 4 - protein, 8 aa, Artificial Sequence
  Synthetic
FPILGVHL

SEQ ID NO: 5 - protein, 9 aa, Artificial Sequence
  Synthetic
AVAIKAMAK

SEQ ID NO: 6 - protein, 9 aa, Artificial Sequence
  Synthetic
GRQGPNANL

SEQ ID NO: 7 - protein, 8 aa, Artificial Sequence
  Synthetic
YPLDGHIL

SEQ ID NO: 8 - protein, 9 aa, Artificial Sequence
  Synthetic
SPRLPVGGF

SEQ ID NO: 9 - protein, 9 aa, Artificial Sequence
  Synthetic
AVMGNPKVK

SEQ ID NO: 10 - protein, 9 aa, Artificial Sequence
  Synthetic
FPVALARAV

SEQ ID NO: 11 - protein, 9 aa, Artificial Sequence
  Synthetic
GRVNVVEAL

SEQ ID NO: 12 - protein, 9 aa, Artificial Sequence
  Synthetic
IVALILSTK

SEQ ID NO: 13 - protein, 9 aa, Artificial Sequence
  Synthetic
RILSGVVTK

SEQ ID NO: 14 - protein, 9 aa, Artificial Sequence
  Synthetic
IINSSITTK

SEQ ID NO: 15 - protein, 9 aa, Artificial Sequence
  Synthetic
YAVTGDVKM

SEQ ID NO: 16 - protein, 9 aa, Artificial Sequence
  Synthetic
MPLNVADLI

SEQ ID NO: 17 - protein, 9 aa, Artificial Sequence
  Synthetic
IIAFVLEGK

SEQ ID NO: 18 - protein, 9 aa, Artificial Sequence
  Synthetic
SPNAEIHIL

SEQ ID NO: 19 - protein, 9 aa, Artificial Sequence
  Synthetic
RVYGGLTTK

SEQ ID NO: 20 - protein, 9 aa, Artificial Sequence
  Synthetic
VPDPNVIKL

SEQ ID NO: 21 - protein, 10 aa, Artificial Sequence
  Synthetic
TVAVPLVGKL

SEQ ID NO: 22 - protein, 9 aa, Artificial Sequence
  Synthetic
LSYNTASNK

SEQ ID NO: 23 - protein, 9 aa, Artificial Sequence
  Synthetic
LANEVKVLL

SEQ ID NO: 24 - protein, 11 aa, Artificial Sequence
  Synthetic
SVASAAAVLSH

SEQ ID NO: 25 - protein, 9 aa, Artificial Sequence
  Synthetic
LPSSFVEKL

SEQ ID NO: 26 - protein, 9 aa, Artificial Sequence
  Synthetic
KVANIILSY

SEQ ID NO: 27 - protein, 9 aa, Artificial Sequence
  Synthetic
GTYQPLSTR

SEQ ID NO: 28 - protein, 9 aa, Artificial Sequence
  Synthetic
ARFGLIQSM

SEQ ID NO: 29 - protein, 9 aa, Artificial Sequence
  Synthetic
GLMGFIVYK

SEQ ID NO: 30 - protein, 9 aa, Artificial Sequence
  Synthetic
SRLTLLTLL

SEQ ID NO: 31 - protein, 9 aa, Artificial Sequence
  Synthetic
LPDPIIIHL

SEQ ID NO: 32 - protein, 10 aa, Artificial Sequence
  Synthetic
LIYVAGGLTK

SEQ ID NO: 33 - protein, 9 aa, Artificial Sequence
  Synthetic
KLLEPVLLL

SEQ ID NO: 34 - protein, 9 aa, Artificial Sequence
  Synthetic
QRVLLLVGF

SEQ ID NO: 35 - protein, 10 aa, Artificial Sequence
  Synthetic
NRFAGFGIGL

SEQ ID NO: 36 - protein, 9 aa, Artificial Sequence
  Synthetic
VVSEKQFSK

SEQ ID NO: 37 - protein, 9 aa, Artificial Sequence
  Synthetic
NAFKEITTM

SEQ ID NO: 38 - protein, 9 aa, Artificial Sequence
  Synthetic
FTNDKIINL

SEQ ID NO: 39 - protein, 11 aa, Artificial Sequence
  Synthetic
VLAPEGSVANK

SEQ ID NO: 40 - protein, 10 aa, Artificial Sequence
  Synthetic
MPAPHTSITM

SEQ ID NO: 41 - protein, 9 aa, Artificial Sequence
  Synthetic
GRWPWQGSL

SEQ ID NO: 42 - protein, 9 aa, Artificial Sequence
  Synthetic
WPVDLVEKL

SEQ ID NO: 43 - protein, 9 aa, Artificial Sequence
  Synthetic
FPSPIRLEF

SEQ ID NO: 44 - protein, 9 aa, Artificial Sequence
  Synthetic
ATYNKQPMY

SEQ ID NO: 45 - protein, 9 aa, Artificial Sequence
  Synthetic
KIYNANYLK

SEQ ID NO: 46 - protein, 9 aa, Artificial Sequence
  Synthetic
DFDMTLSRF

SEQ ID NO: 47 - protein, 10 aa, Artificial Sequence
  Synthetic
VFDEAIRAVL

SEQ ID NO: 48 - protein, 11 aa, Artificial Sequence
  Synthetic
SVSTTNIAGHF

SEQ ID NO: 49 - protein, 10 aa, Artificial Sequence
  Synthetic
AIYATIPVYK

SEQ ID NO: 50 - protein, 9 aa, Artificial Sequence
  Synthetic
AFDLTEQRY

SEQ ID NO: 51 - protein, 9 aa, Artificial Sequence
  Synthetic
YPDINFNRL

SEQ ID NO: 52 - protein, 9 aa, Artificial Sequence
  Synthetic
FVYEPKEQK

SEQ ID NO: 53 - protein, 13 aa, Artificial Sequence
  Synthetic
SLLSGALAGALAK

SEQ ID NO: 54 - protein, 10 aa, Artificial Sequence
  Synthetic
IQFNPPLSEK

SEQ ID NO: 55 - protein, 9 aa, Artificial Sequence
  Synthetic
IQNDRQLQY

SEQ ID NO: 56 - protein, 10 aa, Artificial Sequence
  Synthetic
KLLNYAPLEK

SEQ ID NO: 57 - protein, 11 aa, Artificial Sequence
  Synthetic
VVFVIDPGFAK

SEQ ID NO: 58 - protein, 10 aa, Artificial Sequence
  Synthetic
VLAQYIFTLK

SEQ ID NO: 59 - protein, 11 aa, Artificial Sequence
  Synthetic
GRSTGEAFVQF

SEQ ID NO: 60 - protein, 11 aa, Artificial Sequence
  Synthetic
HIQPGTVNRVS

SEQ ID NO: 61 - protein, 11 aa, Artificial Sequence
  Synthetic
RIYGESADAVK

SEQ ID NO: 62 - protein, 10 aa, Artificial Sequence
  Synthetic
ATLKWILENK

SEQ ID NO: 63 - protein, 11 aa, Artificial Sequence
  Synthetic
FPEPNPRVIEL

SEQ ID NO: 64 - protein, 13 aa, Artificial Sequence
  Synthetic
MPASLGRMNQGTA

SEQ ID NO: 65 - protein, 9 aa, Artificial Sequence
  Synthetic
LPIAASSSL

SEQ ID NO: 66 - protein, 9 aa, Artificial Sequence
  Synthetic
VFDPVPVGV

SEQ ID NO: 67 - protein, 10 aa, Artificial Sequence
  Synthetic
MPLGSAVDIL

SEQ ID NO: 68 - protein, 9 aa, Artificial Sequence
  Synthetic
FPVEVNTVL

SEQ ID NO: 69 - protein, 10 aa, Artificial Sequence
  Synthetic
KLFDHAVSKF

SEQ ID NO: 70 - protein, 11 aa, Artificial Sequence
  Synthetic
RVFVVGVGMTK

SEQ ID NO: 71 - protein, 8 aa, Artificial Sequence
  Synthetic
VSGKPLLI

SEQ ID NO: 72 - protein, 8 aa, Artificial Sequence
  Synthetic
TGYGMPRQ

SEQ ID NO: 73 - protein, 9 aa, Artificial Sequence
  Synthetic
MANGAVIHL

SEQ ID NO: 74 - protein, 9 aa, Artificial Sequence
  Synthetic
FPSAPDVKA

SEQ ID NO: 75 - protein, 9 aa, Artificial Sequence
  Synthetic
MPVGMTHGL

SEQ ID NO: 76 - protein, 9 aa, Artificial Sequence
  Synthetic
SVAQVVLSR

SEQ ID NO: 77 - protein, 9 aa, Artificial Sequence
  Synthetic
SVAKTILKR

SEQ ID NO: 78 - protein, 9 aa, Artificial Sequence
  Synthetic
YPFIIDAHL

SEQ ID NO: 79 - protein, 8 aa, Artificial Sequence
  Synthetic
DAPIVAHL

SEQ ID NO: 80 - protein, 9 aa, Artificial Sequence
  Synthetic
SAAAALVLK

SEQ ID NO: 81 - protein, 9 aa, Artificial Sequence
  Synthetic
KSTGGAPTF

SEQ ID NO: 82 - protein, 9 aa, Artificial Sequence
  Synthetic
APAGRKVGL

SEQ ID NO: 83 - protein, 8 aa, Artificial Sequence
  Synthetic
VTGRAMEL

SEQ ID NO: 84 - protein, 9 aa, Artificial Sequence
  Synthetic
SAADVVVVH

SEQ ID NO: 85 - protein, 9 aa, Artificial Sequence
  Synthetic
GVLGPIINK

SEQ ID NO: 86 - protein, 9 aa, Artificial Sequence
  Synthetic
SSKEGGVTF

SEQ ID NO: 87 - protein, 10 aa, Artificial Sequence
  Synthetic
GTPAGGGFPR

SEQ ID NO: 88 - protein, 9 aa, Artificial Sequence
  Synthetic
ATLNSIVAK

SEQ ID NO: 89 - protein, 9 aa, Artificial Sequence
  Synthetic
TAAAAVRQM

SEQ ID NO: 90 - protein, 9 aa, Artificial Sequence
  Synthetic
VQGVISVPK

SEQ ID NO: 91 - protein, 8 aa, Artificial Sequence
  Synthetic
LQFPVGRI

SEQ ID NO: 92 - protein, 9 aa, Artificial Sequence
  Synthetic
VIKDAIASL

SEQ ID NO: 93 - protein, 9 aa, Artificial Sequence
  Synthetic
GSVDKALEL

SEQ ID NO: 94 - protein, 9 aa, Artificial Sequence
  Synthetic
DALRSGLTV

SEQ ID NO: 95 - protein, 9 aa, Artificial Sequence
  Synthetic
GSVTHVTSF

SEQ ID NO: 96 - protein, 8 aa, Artificial Sequence
  Synthetic
VIRDAVTY

SEQ ID NO: 97 - protein, 9 aa, Artificial Sequence
  Synthetic
EVSGIKAAY

SEQ ID NO: 98 - protein, 8 aa, Artificial Sequence
  Synthetic
MSKLISEM

SEQ ID NO: 99 - protein, 9 aa, Artificial Sequence
  Synthetic
IAKSGTSEF

SEQ ID NO: 100 - protein, 9 aa, Artificial Sequence
  Synthetic
FVKSGGEAF

SEQ ID NO: 101 - protein, 9 aa, Artificial Sequence
  Synthetic
SPIGRDGKL

SEQ ID NO: 102 - protein, 10 aa, Artificial Sequence
  Synthetic
AAFGGNPKSV

SEQ ID NO: 103 - protein, 9 aa, Artificial Sequence
  Synthetic
ATLQEALAH

SEQ ID NO: 104 - protein, 9 aa, Artificial Sequence
  Synthetic
SAAFAVKLF

SEQ ID NO: 105 - protein, 8 aa, Artificial Sequence
  Synthetic
NQIRLTNV

SEQ ID NO: 106 - protein, 9 aa, Artificial Sequence
  Synthetic
SSVPRTAEL

SEQ ID NO: 107 - protein, 9 aa, Artificial Sequence
  Synthetic
HGIDPTGTY

SEQ ID NO: 108 - protein, 9 aa, Artificial Sequence
  Synthetic
VASDLVMKV

SEQ ID NO: 109 - protein, 9 aa, Artificial Sequence
  Synthetic
VPASKRPPL

SEQ ID NO: 110 - protein, 9 aa, Artificial Sequence
  Synthetic
LAKEVGTSY

SEQ ID NO: 111 - protein, 9 aa, Artificial Sequence
  Synthetic
RTYSLGSAL

SEQ ID NO: 112 - protein, 9 aa, Artificial Sequence
  Synthetic
KAIATTVTY

SEQ ID NO: 113 - protein, 9 aa, Artificial Sequence
  Synthetic
DVVRVVGAY

SEQ ID NO: 114 - protein, 9 aa, Artificial Sequence
  Synthetic
SSITASLRF

SEQ ID NO: 115 - protein, 9 aa, Artificial Sequence
  Synthetic
TIKSATISY

SEQ ID NO: 116 - protein, 9 aa, Artificial Sequence
  Synthetic
YADVGGKQF

SEQ ID NO: 117 - protein, 9 aa, Artificial Sequence
  Synthetic
NAFSGVMML

SEQ ID NO: 118 - protein, 9 aa, Artificial Sequence
  Synthetic
ATIIDILTK

SEQ ID NO: 119 - protein, 9 aa, Artificial Sequence
  Synthetic
AANPHSFVF

SEQ ID NO: 120 - protein, 10 aa, Artificial Sequence
  Synthetic
APLPRPGAVL

SEQ ID NO: 121 - protein, 9 aa, Artificial Sequence
  Synthetic
TAFGHPQAY

SEQ ID NO: 122 - protein, 10 aa, Artificial Sequence
  Synthetic
ATGDMSGLLK

SEQ ID NO: 123 - protein, 9 aa, Artificial Sequence
  Synthetic
AAQEAVKLY

SEQ ID NO: 124 - protein, 9 aa, Artificial Sequence
  Synthetic
SAISSVRLY

SEQ ID NO: 125 - protein, 9 aa, Artificial Sequence
  Synthetic
KAMGIMNSF

SEQ ID NO: 126 - protein, 9 aa, Artificial Sequence
  Synthetic
GTMTGMLYK

SEQ ID NO: 127 - protein, 10 aa, Artificial Sequence
  Synthetic
ATIDGSVNPK

SEQ ID NO: 128 - protein, 9 aa, Artificial Sequence
  Synthetic
VTQSEIAQK

SEQ ID NO: 129 - protein, 9 aa, Artificial Sequence
  Synthetic
NTIDPSHPM

SEQ ID NO: 130 - protein, 9 aa, Artificial Sequence
  Synthetic
TTFPRPVTV

SEQ ID NO: 131 - protein, 9 aa, Artificial Sequence
  Synthetic
KAINPINTF

SEQ ID NO: 132 - protein, 9 aa, Artificial Sequence
  Synthetic
DPFLSEKSV

SEQ ID NO: 133 - protein, 9 aa, Artificial Sequence
  Synthetic
KLLGELHTL

SEQ ID NO: 134 - protein, 9 aa, Artificial Sequence
  Synthetic
ATDKSFVEK

SEQ ID NO: 135 - protein, 9 aa, Artificial Sequence
  Synthetic
YMKEVGVGF

SEQ ID NO: 136 - protein, 9 aa, Artificial Sequence
  Synthetic
AAFAYTVKY

SEQ ID NO: 137 - protein, 9 aa, Artificial Sequence
  Synthetic
TIINLAQNF

SEQ ID NO: 138 - protein, 9 aa, Artificial Sequence
  Synthetic
EVVDKINQV

SEQ ID NO: 139 - protein, 9 aa, Artificial Sequence
  Synthetic
AQVPFEQIL

SEQ ID NO: 140 - protein, 9 aa, Artificial Sequence
  Synthetic
YAVDRAITH

SEQ ID NO: 141 - protein, 10 aa, Artificial Sequence
  Synthetic
RPKPPSATSI

SEQ ID NO: 142 - protein, 9 aa, Artificial Sequence
  Synthetic
DPFIIIHSI

SEQ ID NO: 143 - protein, 9 aa, Artificial Sequence
  Synthetic
ISKTNTQTY

SEQ ID NO: 144 - protein, 10 aa, Artificial Sequence
  Synthetic
DRLGQSSMLG

SEQ ID NO: 145 - protein, 9 aa, Artificial Sequence
  Synthetic
RPSLPLPHF

SEQ ID NO: 146 - protein, 9 aa, Artificial Sequence
  Synthetic
ETVSTTLRY

SEQ ID NO: 147 - protein, 9 aa, Artificial Sequence
  Synthetic
KAITFVTQY

SEQ ID NO: 148 - protein, 9 aa, Artificial Sequence
  Synthetic
IAVGHIYYF

SEQ ID NO: 149 - protein, 9 aa, Artificial Sequence
  Synthetic
YAAAQLRQY

SEQ ID NO: 150 - protein, 9 aa, Artificial Sequence
  Synthetic
KAFDYPSLF

SEQ ID NO: 151 - protein, 9 aa, Artificial Sequence
  Synthetic
FINPKPITY

SEQ ID NO: 152 - protein, 9 aa, Artificial Sequence
  Synthetic
YNIQKESTL

SEQ ID NO: 153 - protein, 9 aa, Artificial Sequence
  Synthetic
EVIEKLFAM

SEQ ID NO: 154 - protein, 9 aa, Artificial Sequence
  Synthetic
IAFFDVRTF

SEQ ID NO: 155 - protein, 10 aa, Artificial Sequence
  Synthetic
LAADFEIGHF

SEQ ID NO: 156 - protein, 9 aa, Artificial Sequence
  Synthetic
FQNALLVRY

SEQ ID NO: 157 - protein, 10 aa, Artificial Sequence
  Synthetic
AIQNPTMINK

SEQ ID NO: 158 - protein, 9 aa, Artificial Sequence
  Synthetic
NQIPFIIQY

SEQ ID NO: 159 - protein, 9 aa, Artificial Sequence
  Synthetic
VLWDRTFSL

SEQ ID NO: 160 - protein, 9 aa, Artificial Sequence
  Synthetic
KSFEGLFYF

SEQ ID NO: 161 - protein, 10 aa, Artificial Sequence
  Synthetic
EVIQGDVKSY

SEQ ID NO: 162 - protein, 9 aa, Artificial Sequence
  Synthetic
YLRELLTTM

SEQ ID NO: 163 - protein, 8 aa, Artificial Sequence
  Synthetic
TTGTPLQM

SEQ ID NO: 164 - protein, 9 aa, Artificial Sequence
  Synthetic
NPSILPTAF

SEQ ID NO: 165 - protein, 8 aa, Artificial Sequence
  Synthetic
AQIQVQHV

SEQ ID NO: 166 - protein, 9 aa, Artificial Sequence
  Synthetic
IHVIGGNDV

SEQ ID NO: 167 - protein, 9 aa, Artificial Sequence
  Synthetic
TRIPKIQKL

SEQ ID NO: 168 - protein, 9 aa, Artificial Sequence
  Synthetic
KVYDKAINR

SEQ ID NO: 169 - protein, 9 aa, Artificial Sequence
  Synthetic
GLGSGGSIR

SEQ ID NO: 170 - protein, 12 aa, Artificial Sequence
  Synthetic
SVGKGAVHDVKD

SEQ ID NO: 171 - protein, 9 aa, Artificial Sequence
  Synthetic
GSGPVVPEK

SEQ ID NO: 172 - protein, 7 aa, Artificial Sequence
  Synthetic
YRDANIK

SEQ ID NO: 173 - protein, 8 aa, Artificial Sequence
  Synthetic
DALQGFKI

SEQ ID NO: 174 - protein, 8 aa, Artificial Sequence
  Synthetic
DAPIVAHL

SEQ ID NO: 175 - protein, 9 aa, Artificial Sequence
  Synthetic
LTMPGGVAK

SEQ ID NO: 176 - protein, 8 aa, Artificial Sequence
  Synthetic
TPVRLPSI

SEQ ID NO: 177 - protein, 8 aa, Artificial Sequence
  Synthetic
KGKGQIEK

SEQ ID NO: 178 - protein, 9 aa, Artificial Sequence
  Synthetic
LPRGGLTSI

SEQ ID NO: 179 - protein, 8 aa, Artificial Sequence
  Synthetic
DALKEKVI

SEQ ID NO: 180 - protein, 9 aa, Artificial Sequence
  Synthetic
SVMGVTVSR

SEQ ID NO: 181 - protein, 8 aa, Artificial Sequence
  Synthetic
SFDKAKLK

SEQ ID NO: 182 - protein, 10 aa, Artificial Sequence
  Synthetic
GPPSPPGKPQ

SEQ ID NO: 183 - protein, 9 aa, Artificial Sequence
  Synthetic
SSNIFTVAK

SEQ ID NO: 184 - protein, 9 aa, Artificial Sequence
  Synthetic
SSNLPVNNK

SEQ ID NO: 185 - protein, 10 aa, Artificial Sequence
  Synthetic
GPPPPPGKPE

SEQ ID NO: 186 - protein, 9 aa, Artificial Sequence
  Synthetic
DGYAVDRAI

SEQ ID NO: 187 - protein, 9 aa, Artificial Sequence
  Synthetic
GSSDVIIHR

SEQ ID NO: 188 - protein, 9 aa, Artificial Sequence
  Synthetic
DAPHPPLKI

SEQ ID NO: 189 - protein, 9 aa, Artificial Sequence
  Synthetic
KTKDIVNGL

SEQ ID NO: 190 - protein, 9 aa, Artificial Sequence
  Synthetic
SVLDKSLTK

SEQ ID NO: 191 - protein, 10 aa, Artificial Sequence
  Synthetic
ATGDMSGLLK

SEQ ID NO: 192 - protein, 9 aa, Artificial Sequence
  Synthetic
SSFSGLLRK

SEQ ID NO: 193 - protein, 10 aa, Artificial Sequence
  Synthetic
NAGEDPGLAR

SEQ ID NO: 194 - protein, 9 aa, Artificial Sequence
  Synthetic
GVMTVLIKR

SEQ ID NO: 195 - protein, 9 aa, Artificial Sequence
  Synthetic
IIGTIFIIK

SEQ ID NO: 196 - protein, 9 aa, Artificial Sequence
  Synthetic
GQDVGRYQV

SEQ ID NO: 197 - protein, 9 aa, Artificial Sequence
  Synthetic
DGYVVKETI

SEQ ID NO: 198 - protein, 10 aa, Artificial Sequence
  Synthetic
VNGISKGIIK

SEQ ID NO: 199 - protein, 9 aa, Artificial Sequence
  Synthetic
TTTGHLIYK

SEQ ID NO: 200 - protein, 10 aa, Artificial Sequence
  Synthetic
SLLVGPLVNK

SEQ ID NO: 201 - protein, 9 aa, Artificial Sequence
  Synthetic
AQYLINARL

SEQ ID NO: 202 - protein, 10 aa, Artificial Sequence
  Synthetic
AGDGLIELRK

SEQ ID NO: 203 - protein, 9 aa, Artificial Sequence
  Synthetic
SVQENIQQK

SEQ ID NO: 204 - protein, 10 aa, Artificial Sequence
  Synthetic
STLDIVLANK

SEQ ID NO: 205 - protein, 9 aa, Artificial Sequence
  Synthetic
DAYVLPKLY

SEQ ID NO: 206 - protein, 9 aa, Artificial Sequence
  Synthetic
ILTERGYSF

SEQ ID NO: 207 - protein, 9 aa, Artificial Sequence
  Synthetic
DPFAFIHKI

SEQ ID NO: 208 - protein, 10 aa, Artificial Sequence
  Synthetic
GSYVINGRTK

SEQ ID NO: 209 - protein, 9 aa, Artificial Sequence
  Synthetic
DAHIYLNHI

SEQ ID NO: 210 - protein, 10 aa, Artificial Sequence
  Synthetic
VKKAALVIQQ

SEQ ID NO: 211 - protein, 9 aa, Artificial Sequence
  Synthetic
KTRIIDVVY

SEQ ID NO: 212 - protein, 9 aa, Artificial Sequence
  Synthetic
STIEYVIQR

SEQ ID NO: 213 - protein, 10 aa, Artificial Sequence
  Synthetic
ATGSWDSFLK

SEQ ID NO: 214 - protein, 10 aa, Artificial Sequence
  Synthetic
STTTGHLIYK

SEQ ID NO: 215 - protein, 10 aa, Artificial Sequence
  Synthetic
KVLGVQRPLL

SEQ ID NO: 216 - protein, 10 aa, Artificial Sequence
  Synthetic
AIQNPTMINK

SEQ ID NO: 217 - protein, 9 aa, Artificial Sequence
  Synthetic
GTFGGLGSK

SEQ ID NO: 218 - protein, 9 aa, Artificial Sequence
  Synthetic
VIFTGGVGK

SEQ ID NO: 219 - protein, 9 aa, Artificial Sequence
  Synthetic
ATVTPSPVK

SEQ ID NO: 220 - protein, 9 aa, Artificial Sequence
  Synthetic
AVAIKAMAK

SEQ ID NO: 221 - protein, 9 aa, Artificial Sequence
  Synthetic
IVAGTLTNK

SEQ ID NO: 222 - protein, 9 aa, Artificial Sequence
  Synthetic
ATLNSIVAK

SEQ ID NO: 223 - protein, 9 aa, Artificial Sequence
  Synthetic
AVALPLQTK

SEQ ID NO: 224 - protein, 10 aa, Artificial Sequence
  Synthetic
ATALPTGTSK

SEQ ID NO: 225 - protein, 9 aa, Artificial Sequence
  Synthetic
SVSNVVITK

SEQ ID NO: 226 - protein, 10 aa, Artificial Sequence
  Synthetic
ATVAVPLVGK

SEQ ID NO: 227 - protein, 9 aa, Artificial Sequence
  Synthetic
ATEQPLTAK

SEQ ID NO: 228 - protein, 9 aa, Artificial Sequence
  Synthetic
TVNSKALEI

SEQ ID NO: 229 - protein, 10 aa, Artificial Sequence
  Synthetic
KVAPAPAVVK

SEQ ID NO: 230 - protein, 9 aa, Artificial Sequence
  Synthetic
GQYGNPLNK

SEQ ID NO: 231 - protein, 9 aa, Artificial Sequence
  Synthetic
GTMTGMLYK

SEQ ID NO: 232 - protein, 9 aa, Artificial Sequence
  Synthetic
AINPKLLQL

SEQ ID NO: 233 - protein, 9 aa, Artificial Sequence
  Synthetic
KIYEGQVEV

SEQ ID NO: 234 - protein, 10 aa, Artificial Sequence
  Synthetic
SIFDGRVVAK

SEQ ID NO: 235 - protein, 9 aa, Artificial Sequence
  Synthetic
RSDTPLIYK

SEQ ID NO: 236 - protein, 8 aa, Artificial Sequence
  Synthetic
YAGAILEV

SEQ ID NO: 237 - protein, 9 aa, Artificial Sequence
  Synthetic
ASFDKAKLK

SEQ ID NO: 238 - protein, 9 aa, Artificial Sequence
  Synthetic
RPPPIGAEV

SEQ ID NO: 239 - protein, 9 aa, Artificial Sequence
  Synthetic
GRIVTLISF

SEQ ID NO: 240 - protein, 8 aa, Artificial Sequence
  Synthetic
VSGRILVV

SEQ ID NO: 241 - protein, 8 aa, Artificial Sequence
  Synthetic
VVGKDLTV

SEQ ID NO: 242 - protein, 9 aa, Artificial Sequence
  Synthetic
IHDIQEEEM

SEQ ID NO: 243 - protein, 9 aa, Artificial Sequence
  Synthetic
RVFPWFSVK

SEQ ID NO: 244 - protein, 8 aa, Artificial Sequence
  Synthetic
AMPGVNNL

SEQ ID NO: 245 - protein, 8 aa, Artificial Sequence
  Synthetic
VSLKGCTL

SEQ ID NO: 246 - protein, 9 aa, Artificial Sequence
  Synthetic
VVFPFPVNK

SEQ ID NO: 247 - protein, 9 aa, Artificial Sequence
  Synthetic
GRAPGGLSL

SEQ ID NO: 248 - protein, 9 aa, Artificial Sequence
  Synthetic
DVAVKVLKV

SEQ ID NO: 249 - protein, 9 aa, Artificial Sequence
  Synthetic
KVYENYPTY

SEQ ID NO: 250 - protein, 9 aa, Artificial Sequence
  Synthetic
TAVAPNVAL

SEQ ID NO: 251 - protein, 9 aa, Artificial Sequence
  Synthetic
TSALPIIQK

SEQ ID NO: 252 - protein, 12 aa, Artificial Sequence
  Synthetic
SLLTSSKGQLQK

SEQ ID NO: 253 - protein, 12 aa, Artificial Sequence
  Synthetic
GGFSQGPGNPGN

SEQ ID NO: 254 - protein, 9 aa, Artificial Sequence
  Synthetic
FPNVEIVTI

SEQ ID NO: 255 - protein, 9 aa, Artificial Sequence
  Synthetic
TLYEAVREV

SEQ ID NO: 256 - protein, 9 aa, Artificial Sequence
  Synthetic
PSPRTATPI

SEQ ID NO: 257 - protein, 9 aa, Artificial Sequence
  Synthetic
SHDDIVTEF

SEQ ID NO: 258 - protein, 9 aa, Artificial Sequence
  Synthetic
LPVDLAEEL

SEQ ID NO: 259 - protein, 9 aa, Artificial Sequence
  Synthetic
IGVDFALKV

SEQ ID NO: 260 - protein, 11 aa, Artificial Sequence
  Synthetic
TALLAGLVSLL

SEQ ID NO: 261 - protein, 9 aa, Artificial Sequence
  Synthetic
EVFPLAMNY

SEQ ID NO: 262 - protein, 9 aa, Artificial Sequence
  Synthetic
FAFGEPREL

SEQ ID NO: 263 - protein, 9 aa, Artificial Sequence
  Synthetic
SSVPRTAEL

SEQ ID NO: 264 - protein, 9 aa, Artificial Sequence
  Synthetic
GRWPWQGSL

SEQ ID NO: 265 - protein, 10 aa, Artificial Sequence
  Synthetic
GTPAGGGFPR

SEQ ID NO: 266 - protein, 9 aa, Artificial Sequence
  Synthetic
VTKPVGGNY

SEQ ID NO: 267 - protein, 11 aa, Artificial Sequence
  Synthetic
LLDIQSSGRAK

SEQ ID NO: 268 - protein, 9 aa, Artificial Sequence
  Synthetic
SVSNVVITK

SEQ ID NO: 269 - protein, 9 aa, Artificial Sequence
  Synthetic
SGFEGMFTK

SEQ ID NO: 270 - protein, 9 aa, Artificial Sequence
  Synthetic
STEPPYSQK

SEQ ID NO: 271 - protein, 9 aa, Artificial Sequence
  Synthetic
TTTGHLIYK

SEQ ID NO: 272 - protein, 10 aa, Artificial Sequence
  Synthetic
STTTGHLIYK

SEQ ID NO: 273 - protein, 9 aa, Artificial Sequence
  Synthetic
VFDPVPVGV

SEQ ID NO: 274 - protein, 9 aa, Artificial Sequence
  Synthetic
GQLSVHTPK

SEQ ID NO: 275 - protein, 9 aa, Artificial Sequence
  Synthetic
DGYVVKETI

SEQ ID NO: 276 - protein, 11 aa, Artificial Sequence
  Synthetic
SVYSPSGPVNR